(19) United States
(12) Patent Application Publication
(10) Pub. No.: US 2013/0259131 A1
(43) Pub. Date: Oct. 3, 2013

(54) IMAGE PROCESSING APPARATUS AND METHOD

(71) Applicant: SONY CORPORATION, TOKYO (JP)

(72) Inventor: Kenji KONDO, Tokyo (JP)

(73) Assignee: SONY CORPORATION, TOKYO (JP)

(21) Appl. No.: 13/759,518

(22) Filed: Feb. 5, 2013

(30) Foreign Application Priority Data
Mar. 29, 2012 (JP) 2012-077823

(51) Int. Cl. H04N 7/26

(52) U.S. Cl. CPC H04N 19/00587
USPC 375/240.16

(57) ABSTRACT

An image processing apparatus includes a generation unit, a selection unit, a coding unit, and a transmission unit. The generation unit generates a plurality of pieces of reference block information indicative of different blocks of coded images, which have different viewpoints from a viewpoint of an image of a current block, as reference blocks which refer to motion information. The selection unit selects a block which functions as a referent of the motion information from among the blocks respectively indicated by the plurality of pieces of reference block information. The coding unit codes a differential image between a prediction image of the current block, which is generated with reference to the motion information of the block selected by the selection unit, and the image of the current block. The transmission unit transmits coded data and the reference block information indicative of the block selected by the selection unit.

### BACKGROUND

The present technology relates to an image processing apparatus and method, and, in particular to an image processing apparatus and method which enables coding efficiency to be improved.

In the related art, an apparatus, which receives image information in a digital format and then aims to efficiently transmit and accumulate information at that time based on a method, such as a Moving Picture Experts Group (MPEG) for performing compression using orthogonal transform, such as discrete cosine transform, and motion compensation taking advantage of redundancy which is specific to image information, has been widely used in both information transmission in a broadcasting station and information reception at ordinary homes.

In recent years, a coding method called High Efficiency Video Coding (HEVC) is being standardized by Joint Collaboration Team-Video Coding (JCT-VC) which is a joint standardization organization of International Telecommunication Union Telecommunication Standardization Sector (ITU-T) and International Organization for Standardization (ISO)/International Electro-technical Commission (IEC) for the purpose of further improved coding efficiency compared to H.264 and MPEG-4 Part10 (Advanced Video Coding, hereinafter referred to as “AVC”) (for example, refer to Thomas Wiegand, Woo-Jin Han, Benjamin Bross, Jens-Rainer Ohm, Gary J. Sullivan, “Working Draft 1 of High-Efficiency Video Coding”, JCTVC-C403, Joint Collaborative Team on Video Coding (JCT-VC) of ITU-T SG16 WP3 and ISO/IEC JTC1/SC29/WG113rd Meeting: Guangzhou, Conn., 7-15 Oct., 2010).

In the HEVC coding method, a Coding Unit (CU) is defined as a processing unit which is the same as the macro block of the AVC. Unlike the macro block of the AVC, the size of the CU is not fixed to a 16×16 pixels, and is designated in image compression information in each sequence.

Further, with use of such a coding technology, a use for coding a multi-viewpoint image, which is stereoscopically displayed using parallax, has been proposed.

Incidentally, as one of motion information coding methods, a method (merging mode) called Motion Partition Merging in which a Merge_Flag and a Merge_Left_Flag are transmitted has been proposed (for example, refer to Martin Winken, Sebastian Bosse, Benjamin Bross, Philipp Helle, Tobias Hinz, Heiner Kirchhoffer, Haricharan Lakshman, Detlev Marpe, Simon Oudin, Matthias Preiss, Heiko Schwarz, Mischa Siekmann, Karsten Suchring, and Thomas Wiegand, “Description of video coding technology proposed by Fraunhofer HHI”, JCTVC-A116, April, 2010).

It is considered that such a merging mode is used to code a multi-viewpoint image. In a case of the multi-viewpoint image, since the image includes a plurality of views (images of respective viewpoints), it is possible to use viewpoint prediction using a correlation between the views (parallax directions) in order to further improve coding efficiency.

### SUMMARY

However, there is a possibility that positions of a subject may be deviated from each other in images which have respective views. Therefore, in the case of viewpoint prediction which refers to encoded picture areas which have different viewpoints, if a position, which is close to a current block having a different viewpoint, is referred to cases such as, the spatial prediction and the time prediction in the related art, a motion which is different from the motion of the current block is referred to, with the result that the prediction accuracy of the motion information decreases, and thus there is a problem in that coding efficiency decreases.

It is desirable to improve coding efficiency.

An image processing apparatus according to a first embodiment of the present technology includes: a generation unit that generates a plurality of pieces of reference block information indicative of different blocks of coded images, which have viewpoints different from a viewpoint of an image of a current block, as reference blocks which refer to motion information; a selection unit that selects a block which functions as a referent of the motion information from among the blocks respectively indicated by the plurality of pieces of reference block information which are generated by the generation unit; a coding unit that codes a differential image between a prediction image of the current block, which is generated with reference to the motion information of the block selected by the selection unit, and the image of the current block; and a transmission unit that transmits coded data, which is generated by the coding unit, and the reference block information indicative of the block selected by the selection unit.

The pieces of reference block information may be pieces of identification information to identify the reference blocks.

The respective reference blocks may be blocks which are positioned in different directions from each other, separated from co-located blocks, which are at a same position as the current block, of the coded images which have different viewpoints from the viewpoint of the image of the current block.

The transmission unit may transmit pieces of viewpoint prediction information indicative of positions of the respective reference blocks of the coded images which have different viewpoints from the viewpoint of the image of the current block.

The pieces of viewpoint prediction information may be pieces of information indicative of relative positions of the reference blocks from the co-located blocks located at the same position as the current block.

The pieces of viewpoint prediction information may include pieces of information indicative of distances of the reference blocks from the co-located blocks.

The pieces of viewpoint prediction information may include a plurality of pieces of information indicative of the distances of the reference blocks which are different from each other.

The pieces of the viewpoint prediction information may further include pieces of information indicative of directions of the respective reference blocks from the co-located blocks.

The transmission unit may transmit pieces of flag information indicative of whether or not to use the blocks of the coded images, which have the viewpoints different from the viewpoint of the image of the current block, as the reference blocks.

The coding unit may multi-view code the images.

An image processing method of an image processing apparatus according to a first embodiment of the present technology includes: generating a plurality of pieces of reference block information indicative of different blocks of coded images, which have viewpoints different from a viewpoint of an image of a current block, as reference blocks which refer to motion information; selecting a block which functions as a referent of the motion information from among the blocks respectively indicated by the generated plurality of pieces of reference block information; coding a differential image between a prediction image of the current block, which is generated with reference to the motion information of the selected block, and the image of the current block; and transmitting generated coded data and the reference block information indicative of the selected block.

An image processing apparatus according to a second embodiment of the present technology includes: a reception unit that receives pieces of reference block information indicative of reference blocks which are selected as referents of motion information from among a plurality of blocks of decoded images, which have different viewpoints from a viewpoint of an image of a current block; a generation unit that generates motion information of the current block using pieces of motion information of the reference blocks which are indicated using the pieces of reference block information received by the reception unit; and a decoding unit that decodes coded data of the current block using the motion information which is generated by the generation unit.

The pieces of reference block information may be pieces of identification information indicative of the reference blocks.

The plurality of blocks of the decoded images, which have different viewpoints from the viewpoint of the image of the current block, may be blocks which are positioned in different directions from each other, separated from co-located blocks which are at a same position as the current block.

The image processing apparatus may further include a specification unit that specifies the reference blocks. The reception unit may receive pieces of viewpoint prediction information indicative of positions of the reference blocks of the decoded images, which have different viewpoints from the viewpoint of the image of the current block, the specification unit may specify the reference blocks using the pieces of reference block information received by the reception unit and the pieces of viewpoint prediction information, and the generation unit may generate the motion information of the current block using the pieces of motion information of the reference blocks which are specified by the specification unit.

The pieces of viewpoint prediction information may be pieces of information indicative of relative positions of the reference blocks from the co-located blocks which are at the same position as the current block.

The pieces of viewpoint prediction information may include pieces of information indicative of distances of the reference blocks from the co-located blocks.

The pieces of viewpoint prediction information may include a plurality of pieces of information indicative of the distances of the reference blocks which are different from each other.

The viewpoint prediction information may further include pieces of information indicative of directions of the respective reference blocks from the co-located blocks.

An image processing method of an image processing apparatus according to a second embodiment of the present technology includes: receiving pieces of reference block information indicative of reference blocks which are selected as referents of motion information from among a plurality of blocks of decoded images, which have different viewpoints from a viewpoint of an image of a current block; generating motion information of the current block using pieces of motion information of the reference blocks which are indicated using the received pieces of reference block information; and a decoding unit that decodes coded data of the current block using the generated motion information.

According to the first embodiments of the present technology, the plurality of pieces of reference block information indicative of the different blocks of the coded images, which have different viewpoints from the viewpoint of the image of the current block, are generated as reference blocks which refer to motion information; the block which functions as the referent of the motion information is selected from among the blocks respectively indicated by the generated plurality of pieces of reference block information; the differential image between a prediction image of the current block, which is generated with reference to the motion information of the selected block, and the image of the current block is coded; and the generated coded data and the reference block information indicative of the block selected by the selection unit are transmitted.

According to the second embodiments of the present technology, the pieces of reference block information indicative of reference blocks which are selected as the referents of motion information from among the plurality of blacks of decoded images, which have different viewpoints from the viewpoint of the image of the current block are received; the motion information of the current block using the pieces of motion information of the reference blocks which are indicated using the pieces of reference block information received by the reception unit are generated; and the coded data of the current block is decoded using the motion information which is generated by the generation unit.

According to the present technology, it is possible to process information. In particular, it is possible to improve coding efficiency.

### BRIEF DESCRIPTION OF THE DRAWINGS

FIG. 1 is a view illustrating parallax and a depth;

FIG. 2 is a view illustrating a merging mode;

FIG. 3 is a view illustrating an example of the coding of a multi-viewpoint image;

FIG. 4 is a view illustrating an example of the relationship between the parallax and motion information;

FIG. 5 is a view illustrating another example of the relationship between the parallax and the motion information;

FIG. 6 is a view illustrating an example of a reference block in the merging mode;

FIG. 7 is a view illustrating an example of the reference block in the merging mode;

FIG. 8 is a block diagram illustrating an example of a main configuration of an image coding apparatus;

FIG. 9 is a view illustrating a coding unit;

FIG. 10 is a block diagram illustrating an example of a main configuration of a merging mode processing unit;

FIG. 11 is a view illustrating an example of syntax of a sequence parameter set;

FIG. 12 is a view illustrating an example of the syntax of a picture parameter set;

FIG. 13 is a flowchart illustrating an example of the flow of a sequence coding process;

FIG. 14 is a flowchart illustrating an example of the flow of a sequence parameter set coding process;

FIG. 15 is a flowchart illustrating an example of the flow of a picture coding process;

FIG. 16 is a flowchart illustrating an example of the flow of a picture parameter set coding process;

FIG. 17 is a flowchart illustrating an example of the flow of a slice coding process;

FIG. 18 is a flowchart illustrating an example of the flow of a CU coding process;

FIG. 19 is a flowchart illustrating the example of the flow of the CU coding process which is continued from FIG. 18;

FIG. 20 is a flowchart illustrating an example of the flow of a merging mode process;

FIG. 21 is a flowchart illustrating an example of the flow of a CU merging mode coding process;

FIG. 22 is a flowchart illustrating an example of the flow of a PU coding process;

FIG. 23 is a flowchart illustrating an example of the flow of a TU coding process;

FIG. 24 is a block diagram illustrating an example of the main configuration of an image decoding apparatus;

FIG. 25 is a block diagram illustrating an example of the main configuration of a merging mode processing unit;

FIG. 26 is a flowchart illustrating an example of the flow of a sequence decoding process;

FIG. 27 is a flowchart illustrating an example of the flow of a sequence parameter set decoding process;

FIG. 28 is a flowchart illustrating an example of the flow of a picture decoding process;

FIG. 29 is a flowchart illustrating an example of the flow of a picture parameter set decoding process;

FIG. 30 is a flowchart illustrating an example of the flow of a slice decoding process;

FIG. 31 is a flowchart illustrating an example of the flow of a CU decoding process;

FIG. 32 is a flowchart illustrating an example of the flow of a CU decoding process which is continued from FIG. 31;

FIG. 33 is a flowchart illustrating an example of the flow of a CU merging mode decoding process;

FIG. 34 is a flowchart illustrating an example of the flow of a PU decoding process;

FIG. 35 is a flowchart illustrating an example of the flow of a TU decoding process;

FIG. 36 is a block diagram illustrating an example of the main configuration of a computer;

FIG. 37 is a block diagram illustrating an example of the schematic configuration of a television apparatus;

FIG. 38 is a block diagram illustrating an example of the schematic configuration of a mobile phone;

FIG. 39 is a block diagram illustrating an example of the schematic configuration of a record reproduction apparatus; and

FIG. 40 is a block diagram illustrating an example of the schematic configuration of an imaging apparatus.

### DETAILED DESCRIPTION OF EMBODIMENTS

Hereinafter, forms (hereinafter, referred to as embodiments) to implement the present disclosure will be described. Meanwhile, the description will be performed in the following order:

1. First embodiment (Image coding apparatus)

2. Second embodiment (Image decoding apparatus)

3. Third embodiment (Other method)

4. Fourth embodiment (Computer)

5. Fifth embodiment (Application example)

### 1. First Embodiment

### 1-1. Description of Depth Image (Parallax Image) of the Present Specification

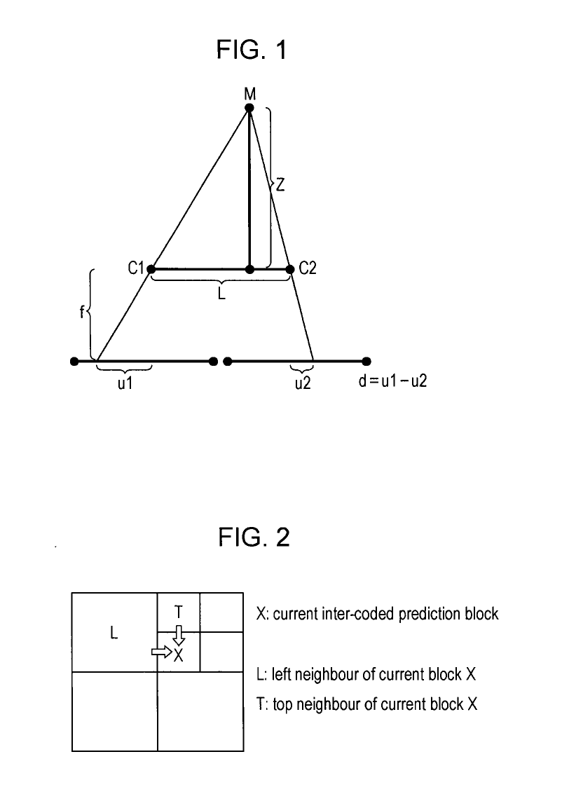

FIG. 1 is a view illustrating parallax and a depth.

As shown in FIG. 1, when a color image of a subject M is taken by a camera c1 which is arranged at a position C1 and a camera c2 which is arranged at a position C2, a depth Z which is a distance of the subject M from the camera c1 (the camera c2) in the depth direction is defined as the following Equation a:

Z=(L/d)*f (a)

Meanwhile, L is a distance between the position C1 and the position C2 in the horizontal direction (hereinafter, referred to as a distance between cameras). In addition, d is a value acquired by subtracting a distance u2 in the horizontal direction from the center of the color image at the position of the subject M on the color image taken by the camera c2, from a distance u1 from the center of the color image at the position of the subject M on the color image taken by the camera c1, that is, a parallax. Further, f is a focal distance of the camera c1, and it is assumed that the focal distance of the camera c1 is the same as the focal distance of the camera c2 in Equation a.

As shown in Equation a, it is possible to perform unique conversion on the parallax d and the depth Z. Therefore, in the present specification, an image which indicates the parallax d of two-viewpoint color images which are taken by the camera c1 and the camera c2, and an image which indicates the depth Z are collectively referred to as a depth image (a parallax image).

Meanwhile, the depth image (the parallax image) may be an image indicative of the parallax d or the depth Z, and it is possible to use a value obtained by normalizing the parallax d and a value obtained by normalizing an inverse number of the depth Z, that is, 1/Z, as the pixel value of the depth image (the parallax image) instead of the parallax d or the depth Z.

It is possible to acquire a value I, obtained by normalizing the parallax d using 8 bits (0 to 255), using the following Equation b. Meanwhile, the number of bits for normalizing the parallax d is not limited to 8 bits, and other number of bits, such as 10 bits or 12 bits, can be used.

I={255*(d−Dₘᵢₙ)}/{Dₘₐₓ−Dₘᵢₙ} (b)

Meanwhile, in Equation b, Dₘₐₓ is the maximum value of the parallax d, and Dₘᵢₙ is the minimum value of the parallax d. The maximum value Dₘₐₓ and the minimum value Dₘᵢₙ may be set in a unit of 1 screen or may be set in a unit of a plurality of screens.

In addition, it is possible to acquire a value y, obtained by normalizing the inverse number 1/Z of the depth Z using 8 bits (0 to 255), using the following Equation c. Meanwhile, the number of bits for normalizing the inverse number 1/Z of the depth Z is not limited to 8 bits, and other number of bits, such as 10 bits or 12 bits, can be used.

y=255*(1/Z−1/Z_{far})/(1/Zₙₑₐᵣ−1/Z_{far}) (c)

Meanwhile, in Equation c, Z_{far} is the maximum value of the depth Z, and Zₙₑₐᵣ is the minimum value of the depth Z. The maximum value Z_{far} and the minimum value Zₙₑₐᵣ may be set in a unit of 1 screen or may be set in a unit of a plurality of screens.

As described above, in the specification, while taking into consideration that the unique conversion can be performed on the parallax d and the depth Z, an image which uses the value I obtained by normalizing the parallax d as the pixel value and an image which uses the value y obtained by normalizing the inverse number 1/Z of the depth Z d as the pixel value are collectively referred to as the depth image (the parallax image). Here, although it is assumed that a color format of the depth image (the parallax image) is YUV420 or YUV400, the depth color image used can be another color format.

Meanwhile, when information about the value I or the value y itself is focused on itself instead of the pixel value of the depth image (the parallax image), the value I or the value y is used as the depth information (parallax information). In addition, a value obtained by mapping the value I or the value y is used as a depth map (a parallax map).

### 1-2. Merging Mode

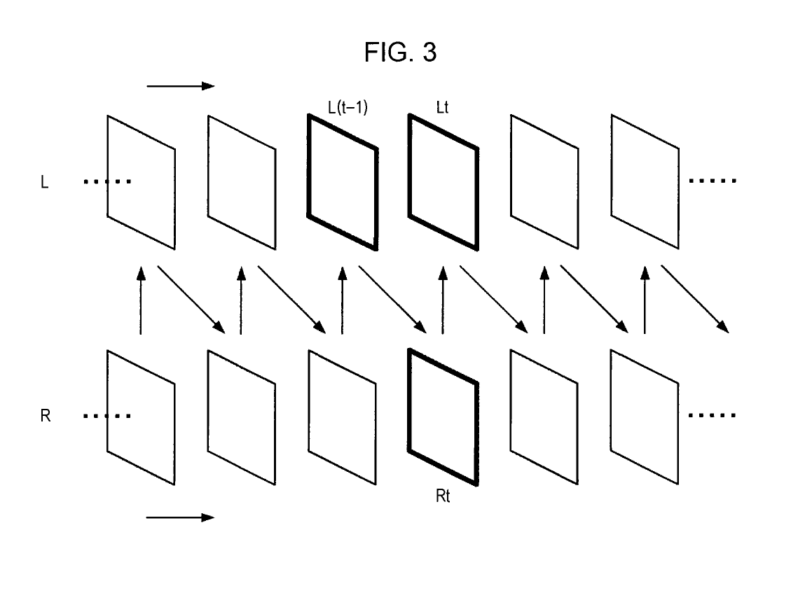

FIG. 2 is a view illustrating a merging mode. In reference to Martin Winken, Sebastian Bosse, Benjamin Bross, Philipp Helle, Tobias Hinz, Heiner Kirchhoffer, Haricharan Lakshman, Detlev Marpe, Simon Oudin, Matthias Preiss, Heiko Schwarz, Mischa Siekmann, Karsten Suchring, and Thomas Wiegand, “Description of video coding technology proposed by Fraunhofer HHI”, JCTVC-A116, April, 2010, a method (a merging mode) called Motion Partition Merging is proposed as one of motion information coding methods, as shown in FIG. 2. In this method, two flags, that is, a Merge_Flag and a Merge_Left_Flag are transmitted as merging information which is information related to the merging mode.

Merge_flag=1 indicates that the motion information of a current block X is the same as that of a neighbour block T which neighbours on the top of the current block X, or the motion information of a current block X is the same as the motion information of a neighbour block L which neighbors on the left of the current block X. At this time, the Merge_Left_Flag is included in the merging information, and transmitted. Merge_flag=0 indicates that the motion information of the current block X is different from the motion information of either the neighbour block T or the neighbour block L. In this case, the motion information of the current block X is transmitted.

When the motion information of the current block X is the same as the motion information of the neighbour block L, Merge_Flag=1 and Merge_Left_Flag=1. When the motion information of the current block X is the same as the motion information of the neighbour block T, Merge_Flag=1 and Merge_Left_Flag=0.

As described above, in the merging mode, a spatial neighbour block is a candidate of a block (reference block) which refers to the motion information. Such prediction of the motion information using correlation in spatial direction is referred to as spatial prediction.

However, in the case of a moving picture, a plurality of pictures having high correlation are arranged in a time direction. Here, in such a merging mode, in addition to the spatial neighbour blocks, temporal neighbour blocks, that is, different picture blocks which have been coded may be the candidates of the reference block in the merging mode. Such prediction using correlation in the time direction is referred to as temporal prediction.

### 1-3. Multi-Viewpoint Image

Further, when a multi-viewpoint image, such as a so-called 3D image, is coded, there are images in a plurality of systems having different viewpoints (views) from each other. That is, a plurality of pictures having high correlation are arranged in viewpoint directions (view directions).

Here, it is assumed that a viewpoint neighbour block, that is, the block of a coded image of another view (a coded image of a view which is different from the view of the current block) is a candidate of the reference block in the merging mode. Such prediction of the motion information using correlation in the viewpoint direction is referred to as viewpoint prediction.

FIG. 3 is a view illustrating an example of the coding of a multi-viewpoint image. For example, when a stereoscopic 3D image, including a view R which is a right eye image and a view L which is a left eye image, is coded, each picture, that is, the view R and the view L are alternately coded as shown using arrows in the drawing.

In FIG. 3, it is assumed that a current picture which is a coding target is a left eye image Lt. In this case, similar to the case of a single viewpoint image, a block which is positioned in the vicinity of (including neighbours on) the current block of the current picture Lt is set to a spatial neighbour block which is the candidate of the reference block in the merging mode.

In addition, similar to the case of the single viewpoint image, for example, a co-located block which is a block positioned at the same position as the current block of a picture L (t−1) (temporal prediction reference picture) which is coded immediately before the current picture Lt or a block which is positioned in the vicinity of the current block is set to a temporal neighbour block which is the candidate of the reference block in the merging mode.

In contrast, a block which is present in a picture Rt at approximately the same time as the current picture of the right eye image is set to the viewpoint neighbour block which is used as the candidate of the reference block in the merging mode.

For example, when correlation in the time direction decreases as immediately after scene-change is generated, and when correlation in the time direction decreases as in the vicinity of the boundary between a moving object and a background, a candidate of the reference block in the merging mode in the viewpoint direction as described above is particularly useful. That is, generally, it is possible to improve coding efficiency by providing the candidate of the reference block in the merging mode in the viewpoint direction.

However, parallax is present between views. That is, the position of an arbitrary subject in a picture differs per each view. Therefore, it may be considered that the information of the co-located block which is a block at approximately the same position as the current block of the picture Rt or a block which is positioned in the vicinity of the current block is significantly different from the motion information of the current block of the picture Lt.

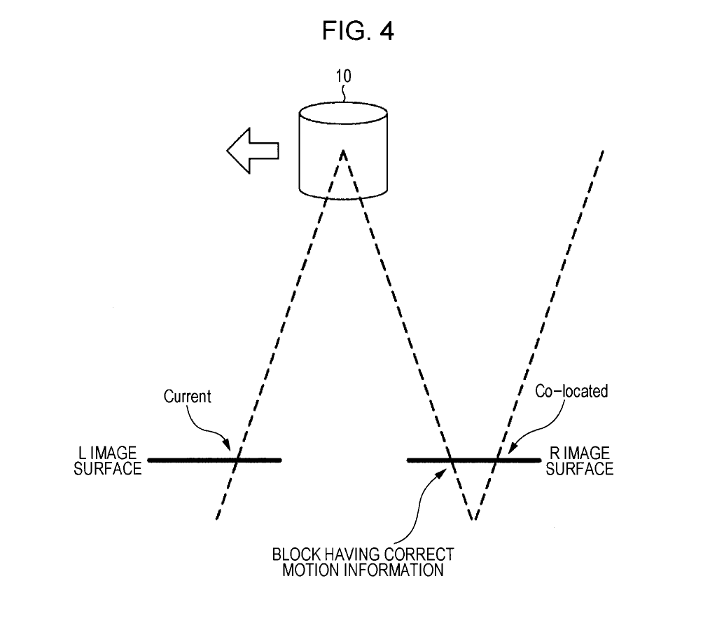

FIG. 4 is a view illustrating an example of the relationship between the parallax and the motion information.

In a case of the example shown in FIG. 4, as shown using a dotted line, the positions of a moving object 10 are different from each other in an L image surface and an R image surface. That is, if it is assumed that the position of the moving object 10 on the L image surface is a current block (Current), the image of the moving object 10 does not exist in a co-located block (Co-located) on the R image surface. Therefore, for example, if the co-located block of the R image surface is set to the referent of motion information, the motion information which is completely different from the motion information of the current block (motion information indicative of the motion of the moving object 10) is acquired.

If a prediction image is generated using the motion information of such a block, there are problems in that the prediction accuracy thereof decreases and coding amount increases. That is, there is a problem in that coding efficiency decreases. In addition, if such a block is set to one of the candidates of the reference block in the merging mode, the block is not selected as a referent because the prediction accuracy is low. That is, such a block does not contribute to the improvement in coding efficiency.

Here, in the case of the viewpoint prediction, a block which has correct motion information is set to the candidate of the reference block instead of the co-located block and the block in the vicinity the reference block.

For example, it may be considered that depth information at current time is predicted based on past depth information and motion information, and then the position of the block which has the correct motion information is predicted based on the predicted depth information. However, in the case of this method, the position of the block which is set to a referent should be obtained in detail, and the processing amount is extremely increased to be unrealistic.

In addition, a method may be considered that adds distance information between the position of a block which has correct motion information and the position of a co-located block, to coded data one by one for each picture. However, in a case of this method, it is not possible to designate the position of the block which has the correct motion information on nothing but a single position in the current picture. Therefore, for example, it is not possible to correctly designate the position of the block which has the correct motion information in an image which has intersecting parallax.

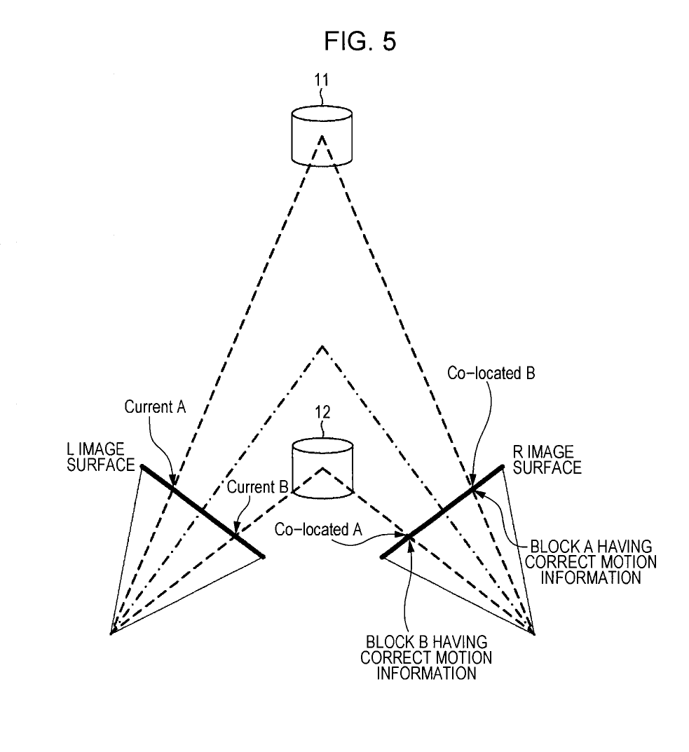

FIG. 5 is a view illustrating another example of the relationship between the parallax and the motion information.

Here, a subject 11 is projected on a current block A (Current A) of the L image surface. In addition, a subject 12 is projected on a current block B (Current B) of the L image surface. The co-located block A (Co-located A) of the R image surface is a block which is at the same position as the current block A (Current A) of the L image surface. The co-located block B (Co-located B) of the R image surface is a block which is at the same position as the current block B (Current B) of the L image surface.

As shown in FIG. 5, a block of the R image surface on which the subject 11 is projected, that is, the block A which has the correct motion information is positioned at the co-located block B, and a block of the R image surface on which the subject 12 is projected, that is, the block B which has the correct motion information is positioned at the co-located block A.

That is, the block A which has the correct motion information is positioned on the right side further than the co-located block A (Co-located A). In contrast, the block B which has the correct motion information is positioned on the left side further than the co-located block B (Co-located B). That is, determination of the positional relationship between the block which has the correct motion information and the co-located block (Co-located) is not necessarily determined to be one in a picture.

### 1-4. Merging Mode when Multi-Viewpoint Image is Coded

Here, when the candidate of the reference block includes a viewpoint neighbour block in the merging mode, a plurality of blocks are set to the candidates of the reference block. That is, a plurality of candidates of the reference block are set to pictures which have different views from that of the current block and which are at approximately the same time as the current block. In this way, it is possible to include a block which has high prediction accuracy in the candidate of the merging mode, and to improve the prediction accuracy. That is, it is possible to improve coding efficiency.

The plurality of blocks may be set at positions which are separated from the co-located block to some extent. The distances may be set depending on, for example, the parallax amount between views. For example, the distance may be set based on the setting information of cameras which images a subject and generates the image of a coding target. In addition, the distances may be input by a user. Further, for the respective blocks, the distances may be set block-by-block to be independent from each other.

In addition, the respective blocks may be set in directions which are different from each other when viewed from the co-located block. For example, in the case of the above-described right and left images, since the images are deviated in the horizontal direction, the block used as the candidate of the reference block in the merging mode may be set in each of the right direction and the left direction of the co-located block.

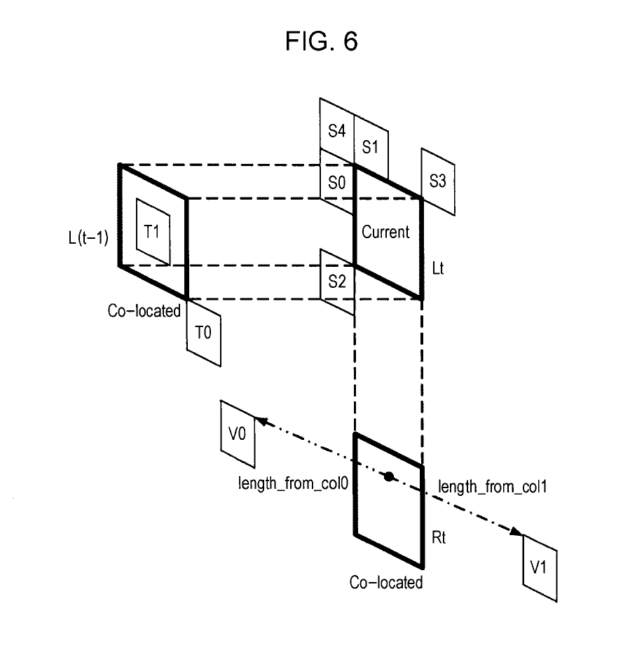

FIG. 6 is a view illustrating an example of the reference block in the merging mode when the 3D image shown in FIG. 3 is coded. In this case, as shown in FIG. 6, not only the spatial neighbour blocks S0 to S4 and the temporal neighbour blocks T0 and T1, but also the viewpoint neighbour blocks V0 and V1 may be set to the reference blocks in the merging mode.

The block V0 is a block which is at a position separated from the co-located block to the left by length_from_col0. The block V1 is a block which is at a position separated from the co-located block to the right by length_from_col1.

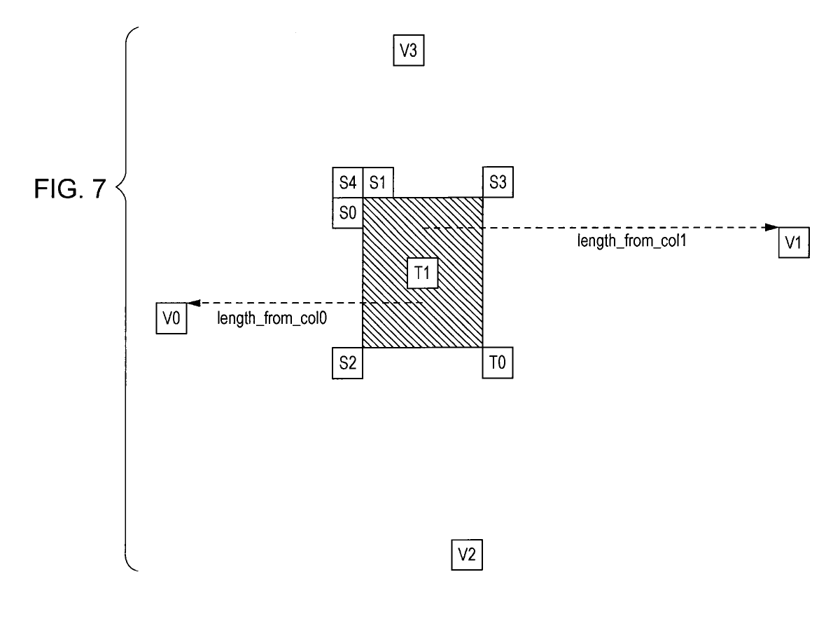

FIG. 7 is a view illustrating the example of the reference block in the merging mode. FIG. 7 shows the mutual spatial positional relationship between the candidates of the reference blocks in the spatial prediction, the temporal prediction, and the viewpoint prediction. A block which is shown using oblique lines indicates the current block.

In this manner, even when there is a possibility that the images may be deviated in both the left direction and the right direction depending on the position of the subject as shown in the example of FIG. 5, it is possible to improve prediction accuracy, and thus it is possible to improve coding efficiency.

Meanwhile, the length_from_col0 indicative of the distance between the current block (the co-located block) and the block V0, and the length_from_col1 indicative of the distance between the current block (co-located block) and the block V1, which are shown in FIGS. 6 and 7, may be transmitted to a decoding side apparatus. For example, the length_from_col0 and the length_from_col1 may be stored at a predetermined position of the coded data, such as a sequence parameter set or a picture parameter set, and may be transmitted to the decoding side. Meanwhile, the length_from_col0 and the length_from_col1 may include information indicative of a direction from the current block. Further, the length_from_col° and the length_from_col1 may be used as information indicative of the relative position from the co-located block which is at the same position as the current block.

Since the parallax amount between views is constant at least in a unit of the picture, the distance between the respective candidates of the co-located block and the reference block may be common in the picture. More exactly, since the amount of deviation between the right and left images varies depending on the position (depth) of the subject as described above, it is preferable that the distance be set for each block depending on the position of the subject. However, in that case, there is a problem in that the processing amount extremely increases. In addition, sufficient prediction accuracy can be acquired by providing a plurality of blocks used as the candidates as described above. Therefore, the distance may be commonized in a unit greater than at least a picture unit.

That is, the distance between the respective candidates of the co-located block and the reference block may be transmitted as the viewpoint prediction information. For example, the distance may be included in the picture parameter set or the sequence parameter set to be transmitted.

In that case, information indicative of the reference block in the merging mode, which is to be transmitted instead of the motion information for each block can be used as identification information which identifies the candidate of the reference block. That is, it is possible to decrease the amount of information to be transmitted for each block, and thus it is possible to improve coding efficiency.

In the decoding side apparatus, it is possible to specify the reference block based on the received identification information and information indicative of the distance from the current block of a block indicated by the identification information.

### 1-5. Image Coding Apparatus

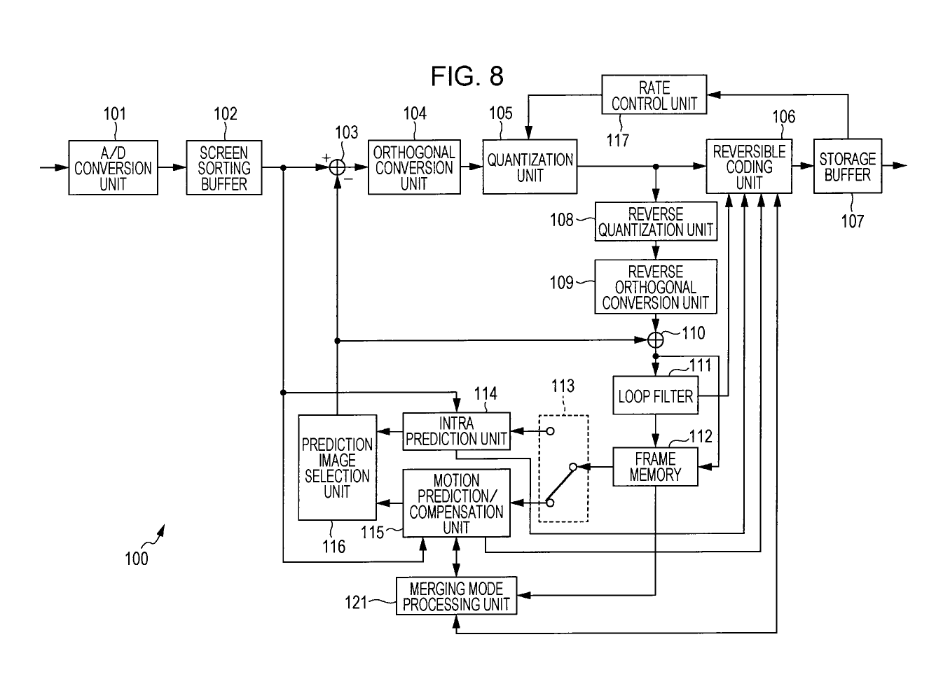

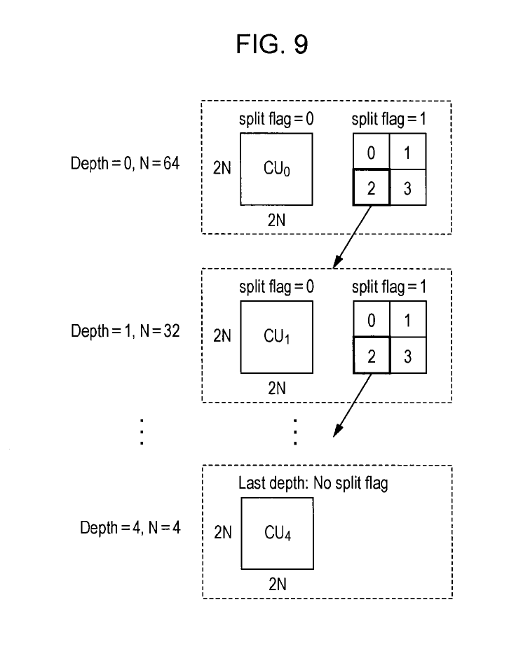

FIG. 8 is a block diagram illustrating an example of a main configuration of an image coding apparatus which is an image processing apparatus to which the present technology is applied.

An image coding apparatus 100 shown in FIG. 8 codes the image data of a moving picture, for example, by use of a High Efficiency Video Coding (HEVC) method or an H.264 and Moving Picture Experts Group (MPEG) 4 Part10 Advanced Video Coding (AVC) method.

The image coding apparatus 100 shown in FIG. 8 includes an A/D conversion unit 101, a screen sorting buffer 102, an operation unit 103, an orthogonal conversion unit 104, a quantization unit 105, a reversible coding unit 106, and a storage buffer 107. In addition, the image coding apparatus 100 includes a reverse quantization unit 108, a reverse orthogonal conversion unit 109, an operation unit 110, a loop filter 111, a frame memory 112, a selection unit 113, an intra prediction unit 114, a motion prediction/compensation unit 115, a prediction image selection unit 116, and a rate control unit 117.

The A/D conversion unit 101 performs A/D conversion on input image data, supplies the image data (digital data), obtained after the conversion is performed, to the screen sorting buffer 102, and causes the image data to be stored. The screen sorting buffer 102 sorts the images of frames in stored display order into an order of frames for coding depending on a Group of Picture (GOP), and supplies the images in which the frame order is sorted, to the operation unit 103. The screen sorting buffer 102 supplies each frame image to the operation unit 103 for each predetermined sub region which is a processing unit (coding unit) of a coding process.

In addition, the screen sorting buffer 102 supplies images in which the frame order is sorted, to the intra prediction unit 114 and the motion prediction/compensation unit 115 for each sub region in the same manner.

The operation unit 103 subtracts the prediction image, which is supplied from the intra prediction unit 114 or the motion prediction/compensation unit 115 via the prediction image selection unit 116, from an image read out from the screen sorting buffer 102, and outputs the differential information thereof to the orthogonal conversion unit 104. For example, in a case of an image on which intra coding is performed, the operation unit 103 subtracts the prediction image, which is supplied from the intra prediction unit 114, from the image which is read out from the screen sorting buffer 102. In addition, for example, in a case of an image on which inter coding is performed, the operation unit 103 subtracts the prediction image, which is supplied from the motion prediction/compensation unit 115, from the image which is read out conversion from the screen sorting buffer 102.

The orthogonal conversion unit 104 performs orthogonal conversion, such as discrete cosine transform or Karhunen-Loeve transformation, on the differential information which is supplied from the operation unit 103. Meanwhile, a method of the orthogonal conversion is arbitrary. The orthogonal conversion unit 104 supplies a conversion coefficient which is acquired by the orthogonal conversion to the quantization unit 105.

The quantization unit 105 quantizes the conversion coefficient which is supplied from the orthogonal conversion unit 104. The quantization unit 105 supplies the quantized conversion coefficient to the reversible coding unit 106.

The reversible coding unit 106 codes the conversion coefficient which is quantized by the quantization unit 105 using an arbitrary coding method, and generates the coded data (bit stream). Since coefficient data is quantized under the control of the rate control unit 117, the coding amount of the coded data is a desired value which is set by the rate control unit 117 (or approximating the desired value).

In addition, the reversible coding unit 106 acquires intra prediction information, which includes information indicative of an intra prediction mode, from the intra prediction unit 114, and acquires inter prediction information, which includes information indicative of the inter prediction mode or motion vector information, from the motion prediction/compensation unit 115. Further, the reversible coding unit 106 acquires a filter coefficient which is used by the loop filter 111.

The reversible coding unit 106 codes these various types of information using an arbitrary coding method, and causes the information to be included (multiplexed) in the coded data (bit stream). The reversible coding unit 106 supplies the coded data which is generated as described above, to the storage buffer 107 to store it.

As the coding method used by the reversible coding unit 106, for example, variable-length coding or arithmetic coding may be used. As the variable-length coding, for example, Context-Adaptive Variable Length Coding (CAVLC) which is determined by the H.264/AVC method may be used. As the arithmetic coding, for example, Context-Adaptive Binary Arithmetic Coding (CABAC) may be used.

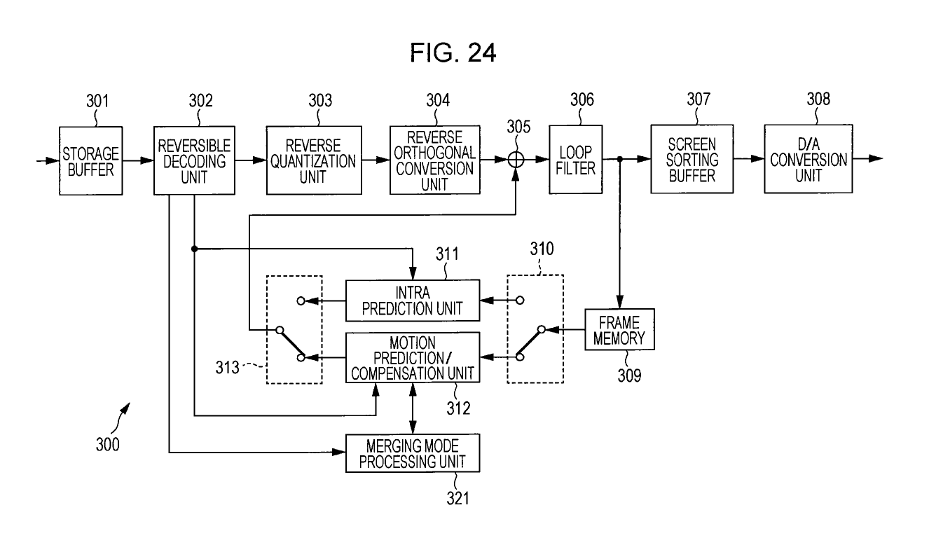

The storage buffer 107 temporarily maintains the coded data which is supplied from the reversible coding unit 106. The storage buffer 107 transforms the coded data which is maintained into a bit stream in a predetermined timing, and outputs the bit stream to, for example, a recording apparatus (recording medium) or a transmission path at a rear end which is not shown in the drawing. That is, the various coded items of information are supplied to an apparatus which decodes coded data acquired in such a way that the image data is coded by the image coding apparatus 100 (hereinafter, referred to as a decoding side apparatus) (for example, an image decoding apparatus 300 which will be described later in FIG. 24).

In addition, the conversion coefficient quantized by the quantization unit 105 is also supplied to the reverse quantization unit 108. The reverse quantization unit 108 performs reverse quantization on the quantized conversion coefficient using a method corresponding to the quantization performed by the quantization unit 105. The reverse quantization unit 108 supplies the acquired conversion coefficient to the reverse orthogonal conversion unit 109.

The reverse orthogonal conversion unit 109 performs reverse orthogonal conversion on the conversion coefficient, which is supplied from the reverse quantization unit 108, using a method corresponding to the orthogonal conversion performed by the orthogonal conversion unit 104. The output (locally decoded differential information) which is obtained through the reverse orthogonal conversion is supplied to the operation unit 110.

The operation unit 110 adds the prediction image, which is supplied from the intra prediction unit 114 or the motion prediction/compensation unit 115, to a result of the reverse orthogonal conversion which is supplied from the reverse orthogonal conversion unit 109, that is, the locally decoded differential information via the prediction image selection unit 116, and acquires a locally reconfigured image (hereinafter, referred to as a reconfigured image). The reconfigured image is supplied to the loop filter 111 or the frame memory 112.

The loop filter 111 includes a deblocking filter and an adaptive loop filter, and performs an appropriate filter process on the reconfigured image which is supplied from the operation unit 110. For example, the loop filter 111 removes the block distortion of the reconfigured image by performing a deblocking filter process on the reconfigured image. In addition, for example, the loop filter 111 improves an image quality by performing the loop filter process on a result of the deblocking filter process (the reconfigured image on which the removal of the block distortion is performed) using a Wiener filter.

Meanwhile, the loop filter 111 may further perform another arbitrary filter process on the reconfigured image. In addition, the loop filter 111, if necessary, may supply information, such as the filter coefficient used for the filter process, to the reversible coding unit 106 to code the information.

The loop filter 111 supplies the result of the filter process (hereinafter, referred to as a decoded image) to the frame memory 112.

The frame memory 112 stores the reconfigured image which is supplied from the operation unit 110 and the decoded image which is supplied from the loop filter 111, respectively. The frame memory 112 supplies the stored reconfigured image to the intra prediction unit 114 via the selection unit 113 in a predetermined timing or based on a request from outside such as the intra prediction unit 114. In addition, the frame memory 112 supplies the stored decoded image to the motion prediction/compensation unit 115 via the selection unit 113 in a predetermined timing or based on a request from outside such as the motion prediction/compensation unit 115.

The selection unit 113 shows the supply destination of the image which is output from the frame memory 112. For example, in the case of the intra prediction, the selection unit 113 reads the image (the reconfigured image) on which the filter process is not performed by the frame memory 112, and supplies the image to the intra prediction unit 114 as neighbour pixels.

In addition, for example, in the case of the inter prediction, the selection unit 113 reads the image (the decoded image) on which the filter process is performed by the frame memory 112, and supplies the image to the motion prediction/compensation unit 115 as a reference image.

When the intra prediction unit 114 acquires an image (neighbour image) of a neighbour area which neighbours on a processing target area from the frame memory 112, the intra prediction unit 114 performs the intra prediction (prediction in a screen), which generates prediction images while a Prediction Unit (PU) is basically used as a processing unit, using the pixel value of the neighbour image. The intra prediction unit 114 performs the intra prediction in a plurality of modes (intra prediction mode) prepared in advance.

That is, the intra prediction unit 114 generates prediction images in all the intra prediction modes which are the candidates, evaluates the cost function value of each prediction image using an input image supplied from the screen sorting buffer 102, and selects an optimal mode. When an optimal intra prediction mode is selected, the intra prediction unit 114 supplies the prediction image which is generated in the optimal mode to the prediction image selection unit 116.

In addition, the intra prediction unit 114 supplies intra prediction information which includes information related to the intra prediction, such as the optimal intra prediction mode, to the appropriate reversible coding unit 106, and codes the intra prediction information.

The motion prediction/compensation unit 115 performs motion prediction (inter prediction) while a PU (inter PU) is basically used as a processing unit using the input image which is supplied from the screen sorting buffer 102 and the reference image which is supplied from the frame memory 112, performs a motion compensation process depending on the detected motion vector prediction image, and generates the prediction image (inter prediction image information). The motion prediction/compensation unit 115 performs the inter prediction in the plurality of modes (inter prediction modes) prepared in advance.

That is, the motion prediction/compensation unit 115 generates all prediction images in inter prediction modes which are the candidate, evaluates the cost function value of each prediction image, and selects an optimal mode. When the optimal inter prediction mode is selected, the motion prediction/compensation unit 115 supplies the prediction image which is generated in the optimal mode to the prediction image selection unit 116.

In addition, the motion prediction/compensation unit 115 supplies inter prediction information which includes information related to the inter prediction, such as the optimal inter prediction mode, to the reversible coding unit 106, and codes the inter prediction information.

The prediction image selection unit 116 selects a supply source of the prediction image to be supplied to the operation unit 103 and the operation unit 110. For example, in a case of intra coding, the prediction image selection unit 116 selects the intra prediction unit 114 as the supply source of the prediction image, and supplies the prediction image which is supplied from the intra prediction unit 114 to the operation unit 103 or the operation unit 110. In addition, for example, in a case of inter coding, the prediction image selection unit 116 selects the prediction/compensation unit 115 as the supply source of the prediction image, and supplies the prediction image which is supplied from the prediction/compensation unit 115 to the operation unit 103 or the operation unit 110.

The rate control unit 117 controls the rate of the quantization operation performed by the quantization unit 105 based on the coding amount of coded data which is stored in the storage buffer 107 such that overflow or underflow does not occur.

Further, the image coding apparatus 100 includes a merging mode processing unit 121 which performs a process related to the merging mode of the inter prediction.

### 1-6. Coding Unit

Incidentally, in the AVC, a layered structure using a macro block and a sub macro block is defined as a coding processing unit (a coding unit). However, when the size of a macro block is set to 16×16 pixels, the size of the macro block is not optimal to a large picture frame called Ultra High Definition (UHD; 4,000×2,000 pixels) which is a target of a next-generation coding method.

Therefore, in High Efficiency Video Coding (HEVC) which is a Post AVC coding method, a Coding Unit (CU) is defined as a coding unit instead of the macro block.

The Coding Unit (CU) is referred to as a Coding Tree Block (CTB), and is a sub region of an image which serves as the same as the macro block in the AVC, and which has a multi-layer structure of an image in a picture unit. That is, the CU is a coding process unit (a coding unit). While the size of the macro block is fixed to 16×16 pixels, the size of the CU is not fixed and designated in image compression information in each sequence.

In particular, a CU which has the maximum size is called the Largest Coding Unit (LCU), and a CU which has the minimum size is called the Smallest Coding Unit (SCU). That is, the LCU is a maximum coding unit, and the SCU is a minimum coding unit. For example, the sizes of these areas are designated in the sequence parameter set which is included in the image compression information, and each of the areas is limited to a size which is a square and is displayed using a power of 2. That is, each area, obtained by dividing a (square) CU in a certain level into 2×2=4, is a (square) CU of one storey down.

FIG. 2 shows an example of the coding unit which is defined in conformity of HEVC. In the example shown in FIG. 2, the size of the LCU is 128 (2N (N=64)), and the largest level depth is 5 (Depth=4). When the value of a split_flag is “1”, a CU having a size of 2N×2N is divided into CUs each having a size of N×N which is one storey down.

Further, the CU is divided into Prediction Units (PUs), each of which is an area functioning as the processing unit of intra or inter prediction (the sub region of an image in a unit of the picture), and is divided into Transform Units (TUs), each of which is an area functioning as the processing unit of orthogonal conversion (the sub region of an image in a unit of the picture).

In a case of an inter prediction unit PU, four sizes, that is, 2N×2N, 2N×N, N×2N, and N×N, can be set to a CU having a size of 2N×2N. That is, with regard to a single CU, it is possible to define a single PU having the same size as the CU, two PUs obtained by vertically or horizontally dividing the CU, or four PUs obtained by vertically and horizontally dividing the CU into two.

The image coding apparatus 100 performs each process related to coding while using such a sub region of an image in a unit of the picture as a processing unit. Hereinafter, a case in which the image coding apparatus 100 uses a CU defined in conformity of HEVC as a coding unit will be described. That is, an LCU is the maximum coding unit, and an SCU is the minimum coding unit. However, the processing unit used for coding performed by the image coding apparatus 100 is not limited thereto, and any arbitrary processing unit may be used. For example, the macro block or the sub macro block which is defined in conformity of the AVC may be set to a processing unit.

Meanwhile, hereinafter, a “block” includes all of the various types of areas (for example, the macro block, the sub macro block, the LCU, the CU, the SCU, the PU, and the TU) (every area can be used). It is apparent that a unit which is not described above may be included, and an unacceptable unit is appropriately removed depending on the content of description.

### 1-7. Merging Mode Processing Unit

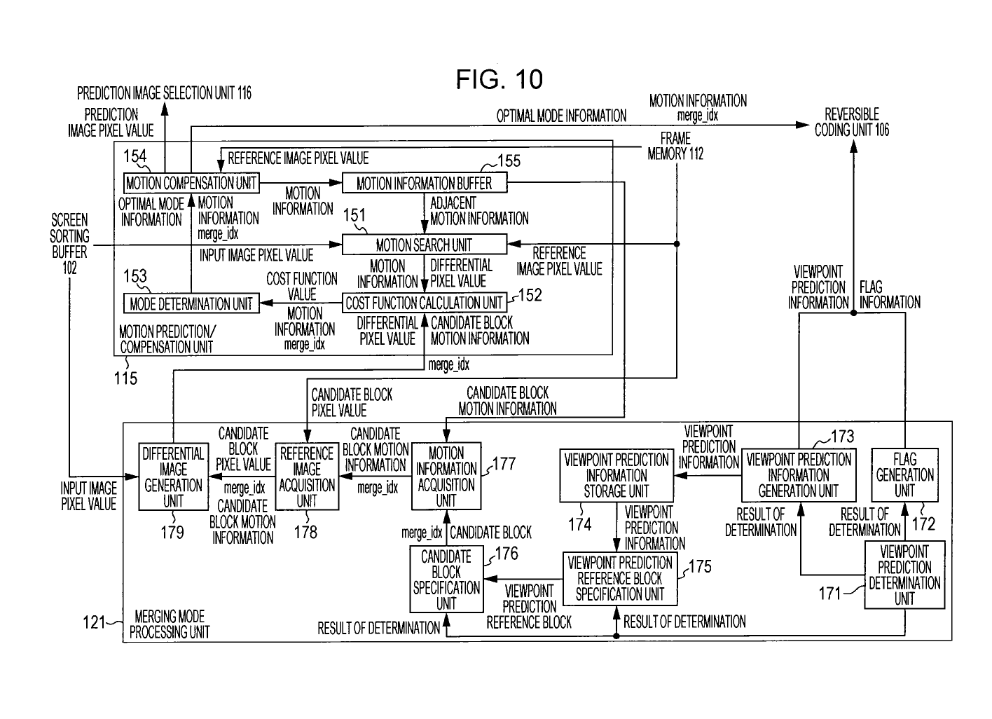

FIG. 10 is a block diagram illustrating an example of the main configuration of the merging mode processing unit.

As shown in FIG. 10, the motion prediction/compensation unit 115 includes a motion search unit 151, a cost function calculation unit 152, a mode determination unit 153, a motion compensation unit 154, and a motion information buffer 155.

In addition, the merging mode processing unit 121 includes a viewpoint prediction determination unit 171, a flag generation unit 172, a viewpoint prediction information generation unit 173, a viewpoint prediction information storage unit 174, a viewpoint prediction reference block specification unit 175, a candidate block specification unit 176, a motion information acquisition unit 177, a reference image acquisition unit 178, and a differential image generation unit 179.

An input image pixel value from the screen sorting buffer 102 and a reference image pixel value from the frame memory 112 are input to the motion search unit 151. Further, the motion search unit 151 acquires neighbour motion information, which is the motion information of a neighbour block which neighbours on the current block and coded in the past, from the motion information buffer 155. The motion search unit 151 performs a motion search process with regard to all the inter prediction modes, and generates the motion information which includes a motion vector and reference index. The motion search unit 151 supplies the motion information to the cost function calculation unit 152.

In addition, the motion search unit 151 performs a compensation process on the reference image using a found motion vector, and generates a prediction image. Further, the motion search unit 151 calculates the differential image between the prediction image and the input image, and supplies a differential pixel value which is the pixel value thereof to the cost function calculation unit 152.

The cost function calculation unit 152 acquires the differential pixel value in each inter prediction mode from the motion search unit 151. In addition, the cost function calculation unit 152 acquires information, such as the differential pixel value, the candidate block motion information, and the identification information merge_idx, from the differential image generation unit 179 of the merging mode processing unit 121.

The cost function calculation unit 152 calculates the cost function value in each inter prediction mode (including the merging mode) using the differential pixel value. The cost function calculation unit 152 supplies information, such as the cost function value, motion information, and merge_idx in each inter prediction mode, to the mode determination unit 153.

The mode determination unit 153 acquires information of each inter prediction mode, such as the cost function value, the motion information, and the merge_idx, from the cost function calculation unit 152. The mode determination unit 153 selects a mode which has the smallest cost function value from all the inter prediction modes as the optimal mode. The mode determination unit 153 supplies optimal mode information, which is information indicative of the inter prediction mode selected as the optimal mode, to the motion compensation unit 154, together with the motion information or the merge_idx of the inter prediction mode selected as the optimal mode.

The motion compensation unit 154 acquires information, such as the optimal mode information, the motion information, or the merge_idx, which is supplied from the mode determination unit 153. The motion compensation unit 154 acquires the reference image pixel value of the inter prediction mode, which is displayed based on the optimal mode information, from the frame memory 112 using the motion information or merge_idx, and generates the prediction image of the inter prediction mode which is displayed based on the optimal mode information.

The motion compensation unit 154 supplies the generated prediction image pixel value to the prediction image selection unit 116. In addition, the motion compensation unit 154 supplies the information, such as the optimal mode information, the motion information, or the merge_idx, to the reversible coding unit 106, and transmits the information to the decoding side.

In addition, the motion compensation unit 154 supplies the motion information or the merge_idx indicated by the motion information to the motion information buffer 155 to store it.

The motion information buffer 155 stores the motion information which is supplied from the motion compensation unit 154, and supplies the stored motion information to the motion search unit 151 as the motion information (neighbour motion information) of the coded neighbour block which neighbours on the current block. In addition, the motion information buffer 155 supplies the stored motion information to the motion information acquisition unit 177 of the merging mode processing unit 121 as the candidate block motion information.

The viewpoint prediction determination unit 171 of the merging mode processing unit 121 determines whether or not to refer to the motion information of the neighbour block in the viewpoint direction (to perform the viewpoint prediction) based on, for example, an instruction from the outside, such as the user, or the types of the image of the coding target, and notifies the flag generation unit 172 of the result of determination. The flag generation unit 172 sets the value of a flag information merge_support_{—}3d_flag based on the result of determination.

For example, when the image of the coding target is a 3D image which has right and left views, the viewpoint prediction determination unit 171 determines to perform the viewpoint prediction, and the flag generation unit 172 sets the value of the merge_support_{—}3d_flag to a value (for example, 1) which indicates that the candidate of the reference block in the merging mode includes a neighbour block in the viewpoint direction (a viewpoint prediction reference block).

In addition, for example, when the image of the coding target is a 2D image which includes a single view, the viewpoint prediction determination unit 171 determines not to perform the viewpoint prediction, and the flag generation unit 172 sets the value of the merge_support_{—}3d_flag to a value (for example, 0) which indicates that the candidate of the reference block in the merging mode does not include a neighbour block in the viewpoint direction (a viewpoint prediction reference block).

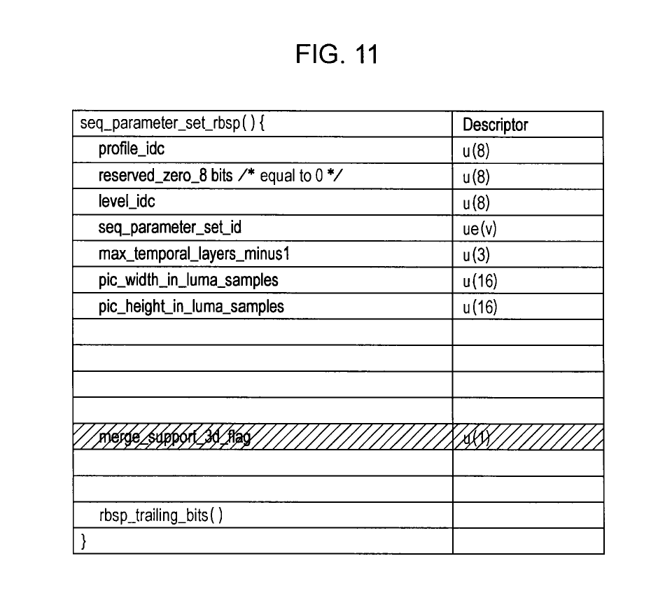

Meanwhile, the flag generation unit 172 may generate flag information in addition to the merge_support_{—}3d_flag. The flag generation unit 172 supplies the flag information which includes the merge_support_{—}3d_flag to the reversible coding unit 106, and transmits the flag information to the decoding side. The reversible coding unit 106 includes the flag information in the sequence parameter set as in, for example, the syntax shown in FIG. 11, and transmits the flag information to the decoding side. It is apparent that the flag information may be stored in an arbitrary area, for example, the picture parameter set, in addition to the sequence parameter set. In addition, the flag information may be transmitted as separate data from the coded data.

If the number of candidates of the reference blocks increases, there are problems in that the load of the coding process increases and the coding amount increases. Therefore, it is possible to change the number of candidates of the reference blocks by determining whether or not to perform the viewpoint prediction and transmitting flag information indicative of the determination thereof. That is, since the number of candidates of the reference blocks can be recognized based on the flag information, the decoding side apparatus can correctly recognize the identification information of the reference blocks even when the number of candidates changes. That is, it is possible to suppress the increase in the number of unnecessary candidates of the reference blocks by transmitting the merge_support_{—}3d_flag.

Meanwhile, whether or not to perform the viewpoint prediction is depending on the number of views of an image. That is, if the number of views does not change, the value of the merge_support_{—}3d_flag is constant. Generally, the number of views is determined for each sequence. At least, the number of views is not changed in a picture. Therefore, there is a little increase in the amount of information by adding the merge_support_{—}3d_flag. Compared to this, if the number of candidates of the reference blocks increases, the amount of information of each block increases. That is, it is possible to suppress the increase in the coding amount by transmitting the merge_support_{—}3d_flag, and thus it is possible to improve coding efficiency.

The viewpoint prediction determination unit 171 further supplies the result of the determination to the viewpoint prediction information generation unit 173, the viewpoint prediction reference block specification unit 175, and the candidate block specification unit 176.

When the viewpoint prediction information generation unit 173 determines to perform the viewpoint prediction based on the result of the determination, the viewpoint prediction information generation unit 173 generates viewpoint prediction information which includes information (length_from_col0 and length_from_col1) indicative of the distance between the co-located block and the candidate of the reference block in a picture which has a different view from the current block and which is at the approximately same time as the current block. The distance may be determined in advance, may be determined based on the parallax information between views of the image of the coding target, and may be determined based on the setting information of the camera which images a subject and generates the image of the coding target. In addition, the distance may be designated from the outside such as the user.

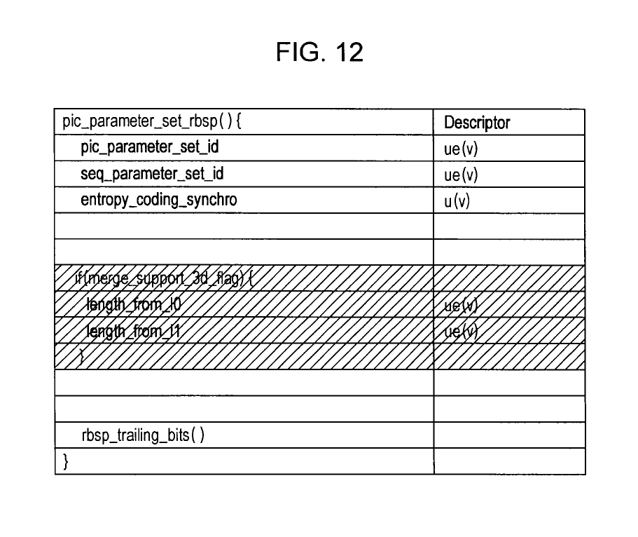

The viewpoint prediction information generation unit 173 supplies the generated viewpoint prediction information to the reversible coding unit 106, and transmits the viewpoint prediction information to the decoding side apparatus. The reversible coding unit 106 includes the viewpoint prediction information in the picture parameter set as, for example, the syntax shown in FIG. 12, and transmits the viewpoint prediction information to the decoding side. It is apparent that the viewpoint prediction information may be stored in an arbitrary area, for example, the sequence parameter set, in addition to the picture parameter set. In addition, the viewpoint prediction information may be transmitted as separate data from the coded data.

The viewpoint prediction information generation unit 173 supplies the generated viewpoint prediction information to the viewpoint prediction information storage unit 174. The viewpoint prediction information storage unit 174 stores the viewpoint prediction information. The viewpoint prediction information storage unit 174 supplies the stored viewpoint prediction information to the viewpoint prediction reference block specification unit 175, for example, at the request from outside, such as the viewpoint prediction reference block specification unit 175.

When the viewpoint prediction reference block specification unit 175 determines to perform the viewpoint prediction based on the result of determination performed by the viewpoint prediction determination unit 171, the viewpoint prediction reference block specification unit 175 acquires the viewpoint prediction information from the viewpoint prediction information storage unit 174, and specifies a plurality of viewpoint prediction reference blocks which are the candidates of the reference block in the viewpoint direction in the merging mode based on the viewpoint prediction information. For example, the point prediction reference block specification unit 175 specifies a block V0 for the current block using the length_from_col0, and specifies a block V1 for the current block using the length_from_col1.

The viewpoint prediction reference block specification unit 175 supplies information, which is indicative of the specified viewpoint prediction reference block, to the candidate block specification unit 176.

The candidate block specification unit 176 specifies a block (a candidate block) which is used as the candidate of the reference block in the merging mode. The candidate block specification unit 176 specifies a block which is used as a spatial directional candidate of the reference block in the merging mode and a block which is used as a time directional candidate.

Thereafter, when the candidate block specification unit 176 determines to perform the viewpoint prediction based on the result of determination performed by the viewpoint prediction determination unit 171, the candidate block specification unit 176 includes a viewpoint directional candidate in the candidate block, together with the spatial directional and the time directional candidates. In addition, when it is determined to not perform the viewpoint prediction based on the result of determination performed by the viewpoint prediction determination unit 171, the candidate block specification unit 176 includes the spatial directional and time directional candidates in the candidate block.

The candidate block specification unit 176 supplies information which is indicative of the position of the candidate block specified in this manner and the identification information merge_idx which is used to identify each candidate, to the motion information acquisition unit 177.

The motion information acquisition unit 177 acquires the motion information of each candidate block (the candidate block motion information) from the motion information buffer 155, and supplies the motion information of each candidate block to the reference image acquisition unit 178, together with the identification information merge_idx.

The reference image acquisition unit 178 acquires a reference image (the candidate block pixel value), which corresponds to each motion information, from the frame memory 112. The reference image acquisition unit 178 supplies the acquired each reference image (the candidate block pixel value) to the differential image generation unit 179, together with the identification information merge_idx and the candidate block motion information.

The differential image generation unit 179 generates the differential image (differential pixel value) between the input image (the input image pixel value) which is acquired from the screen sorting buffer 102 and each reference image (the candidate block pixel value) which is acquired from the reference image acquisition unit 178. The differential image generation unit 179 supplies the generated each differential image (the differential pixel value) to the cost function calculation unit 152, together with the identification information merge_idx and the candidate block motion information.

The cost function calculation unit 152 calculates the cost function value for each candidate block. When any of cost function values of these candidate blocks is the smallest, the mode determination unit 153 uses the merging mode as the optimal inter prediction mode, and determines the candidate block as the reference block. In this case, the mode determination unit 153 supplies the identification information merge_idx to the motion compensation unit 154, together with the optimal mode information. The motion compensation unit 154 generates a prediction image and supplies the generated prediction image to the prediction image selection unit 116, supplies the optimal mode information and the identification information merge_idx to the reversible coding unit 106, and transmits the optimal mode information and the identification information merge_idx to the decoding side apparatus. The reversible coding unit 106 includes the information in, for example, the coded data, and transmits the information. It is apparent that the information may be transmitted as separate data from the coded data.

As described above, the viewpoint prediction reference block specification unit 175 specifies the plurality of viewpoint prediction reference blocks, with the result that the image coding apparatus 100 improves the prediction accuracy in the merging mode, and thus it is possible to improve coding efficiency.

### 1-8. Flow of Process

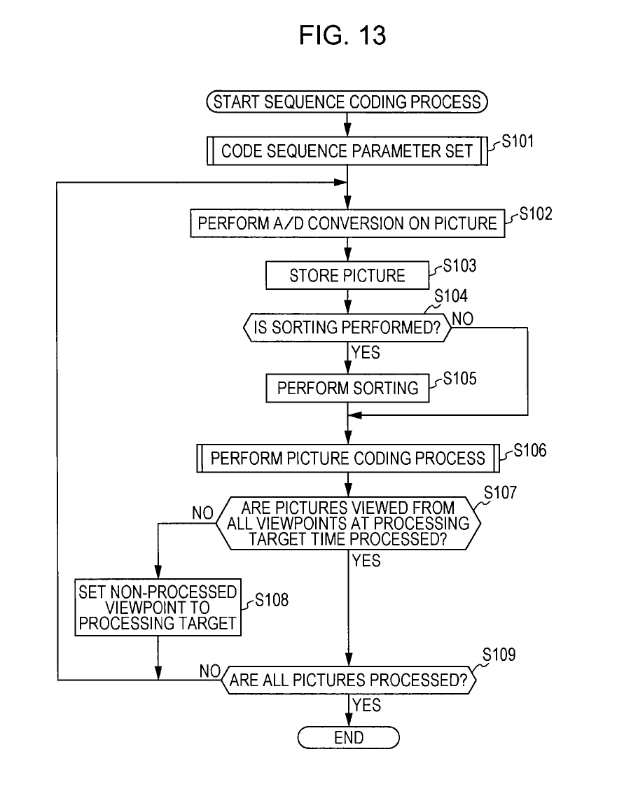

Subsequently, a flow of each process which is performed by the above-described image coding apparatus 100 will be described. First, an example of the flow of the sequence coding process will be described with reference to a flowchart shown in FIG. 13.

In step S101, the reversible coding unit 106 and the merging mode processing unit 121 codes a sequence parameter set.

In step S102, the A/D conversion unit 101 performs A/D conversion on input pictures. In step S103, the screen sorting buffer 102 stores the pictures obtained through the A/D conversion.

In step S104, the screen sorting buffer 102 determines whether or not to sort the pictures. When it is determined to sort the pictures, the process proceeds to step S105. In step S105, the screen sorting buffer 102 sorts the pictures. When the pictures are sorted, the process proceeds to step S106. In addition, in step S104, when it is determined to not sort the pictures, the process proceeds to step S106.

In step S106, the operation unit 103 to the rate control unit 117, and the merging mode processing unit 121 perform the picture coding process to code a current picture which is the processing target.

In step S107, the image coding apparatus 100 determines whether or not pictures viewed from all the viewpoints at a processing target time are processed. When it is determined that a non-processed viewpoint is present, the process proceeds to step S108.

In step S108, the image coding apparatus 100 sets the non-processed viewpoint to a processing target. The process returns to step S102, and the processes thereafter are repeated. That is, the processes in steps S102 to S108 are executed with regard to each viewpoint.

In step S107, when it is determined that pictures viewed from all the viewpoints at the processing target time are processed, the process proceeds to step S109, and pictures at a subsequent time are set to the processing target.

In step S109, the image coding apparatus 100 determines whether or not all the pictures are processed. When it is determined that a non-processed picture is present, the process returns to step S102, and the processes thereafter are repeated. That is, pictures viewed from all the viewpoints all the time are coded (that is, pictures in all the sequences) by repeatedly executing the processes in steps S102 to S109.

When it is determined that all the pictures are coded in step S109, the sequence coding process is terminated.

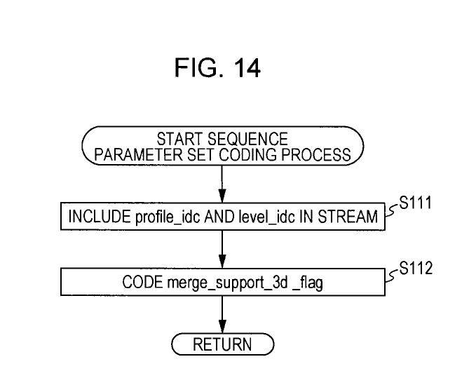

Subsequently, an example of the flow of a sequence parameter set coding process will be described with reference to a flowchart in FIG. 14.

In step S111, the reversible coding unit 106 includes a profile_idc and a level_idc in a stream (coded data).

In addition, the flag generation unit 172 generates flag information which includes a merge_support_{—}3d_flag, and supplies the flag information to the reversible coding unit 106. The reversible coding unit 106 codes the flag information, and includes the coded flag information in, for example, the sequence parameter set of the coded data in step S112. The decoding side apparatus can recognize whether or not a viewpoint prediction reference block is included in the candidate of the reference block in the merging mode using the merge_support_{—}3d_flag.

When the process in step S112 is terminated, the process returns to FIG. 13.

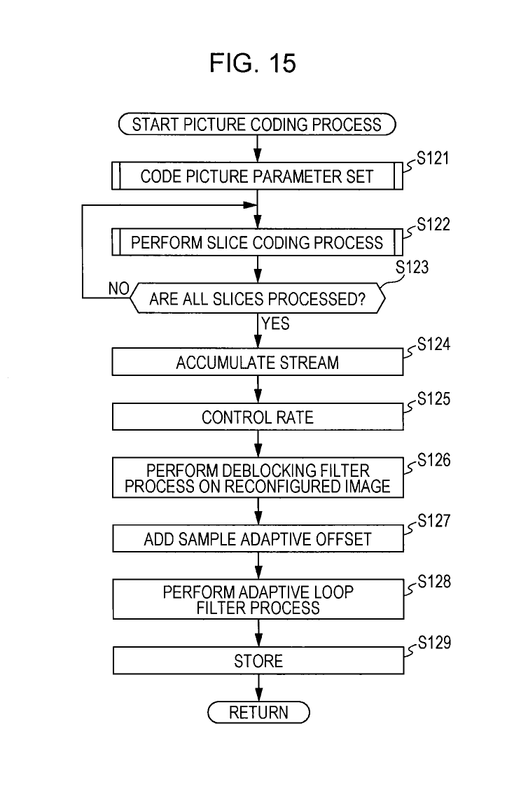

Subsequently, an example of the flow of a picture coding process will be described with reference to a flowchart in FIG. 15.

In step S121, the reversible coding unit 106 codes the picture parameter set.

In step S122, the operation unit 103 to the reversible coding unit 106, the reverse quantization unit 108 to the operation unit 110, the selection unit 113 to the prediction image selection unit 116, and the merging mode processing unit 121 perform the slice coding process to code a current slice which is a processing target in the current picture.

In step S123, the image coding apparatus 100 determines whether or not all the slices in the current picture are coded. When a non-processed slice is present, the process returns to step S122. That is, the process in step S122 is performed on all the slices. In step S123, when it is determined that all the slices in the current picture are processed, the process proceeds to step S124.

In step S124, the storage buffer 107 stores and accumulates the coded data (stream) of the processing target picture which is generated by the reversible coding unit 106.

In step S125, the rate control unit 117 controls the rate of the coded data by controlling the parameter of the quantization unit 105 based on the coding amount of the coded data which is accumulated in the storage buffer 107.

In step S126, the loop filter 111 performs the deblocking filter process on the reconfigured image which is generated through the process performed in step S122. In step S127, the loop filter 111 adds sample adaptive offset. In step S128, the loop filter 111 performs the adaptive loop filter process.

In step S129, the frame memory 112 stores a decoded image on which the filter process is performed as described above.

When the process in step S129 is terminated, the process returns to FIG. 13.

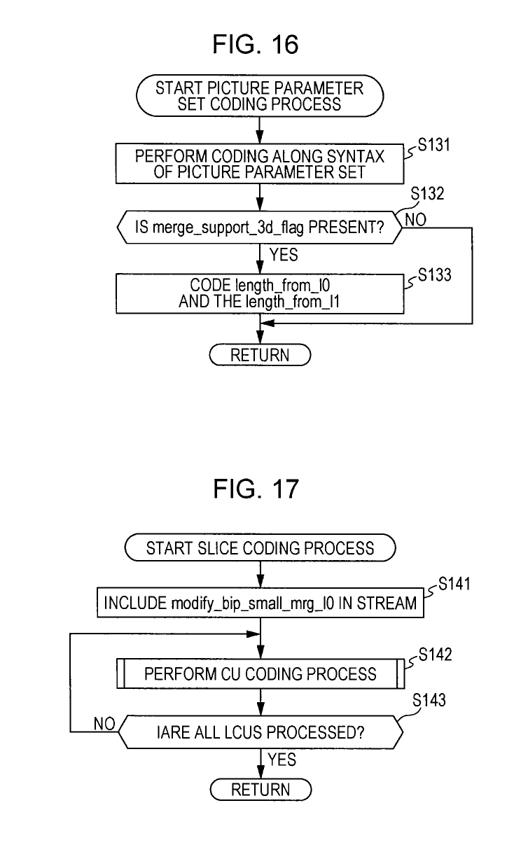

Subsequently, an example of the flow of a picture parameter set coding process will be described with reference to a flowchart in FIG. 16.

In step S131, the reversible coding unit 106 performs coding along the syntax of the picture parameter set.

In step S132, the viewpoint prediction determination unit 171 determines whether or not the neighbour block in the viewpoint direction is included as the candidate of the reference block in the merging mode. When it is determined that the neighbour block in the viewpoint direction is included, the process proceeds to step S133.

In this case, the viewpoint prediction information generation unit 173 generates viewpoint prediction information. In step S133, the reversible coding unit 106 codes the viewpoint prediction information (the length_from_col0 and the length_from_col1), and includes the viewpoint prediction information in the picture parameter set.

When the process in step S133 is terminated, the process returns to FIG. 15. In addition, in step S132, when it is determined that the neighbour block in the viewpoint direction is not included, the process returns to FIG. 15.

Subsequently, an example of the flow of a slice coding process will be described with reference to a flowchart in FIG. 17.

In step S141, the reversible coding unit 106 includes modify_bip_small_mrg_{—}10 in a stream.

In step S142, the operation unit 103 to the reversible coding unit 106, the reverse quantization unit 108 to the operation unit 110, the selection unit 113 to the prediction image selection unit 116, and the merging mode processing unit 121 perform the CU coding process to code a current CU which is a processing target in a current slice.

In step S143, the image coding apparatus 100 determines whether or not all the LCUs in the current slice are processed. When it is determined that a non-processed LCU is present in the current slice, the process returns to step S142. That is, the process in step S142 is performed on all the LCUs in the current slice.

In step S143, when it is determined that all the LCUs in the current slice are processed, the process returns to FIG. 15.

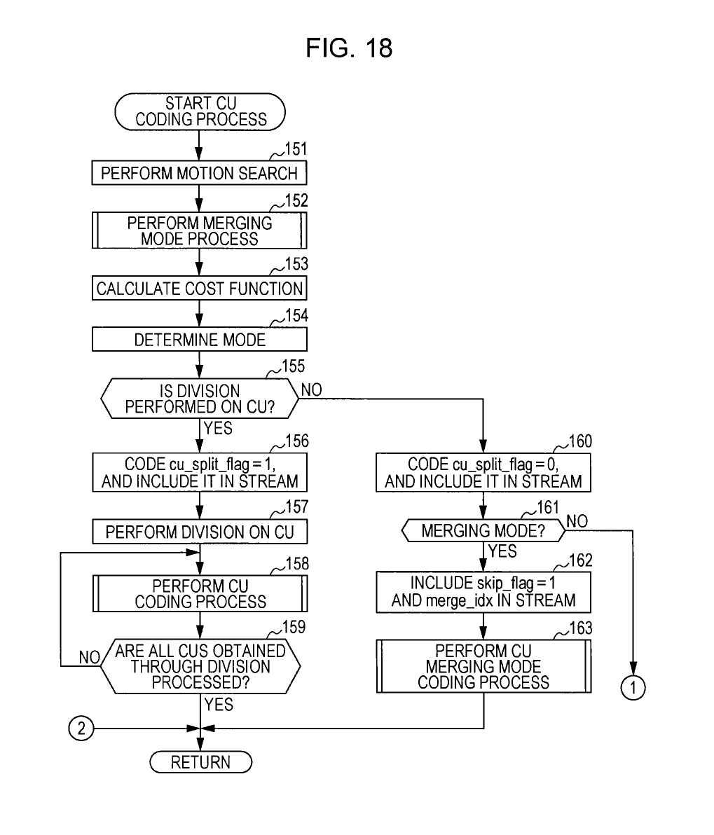

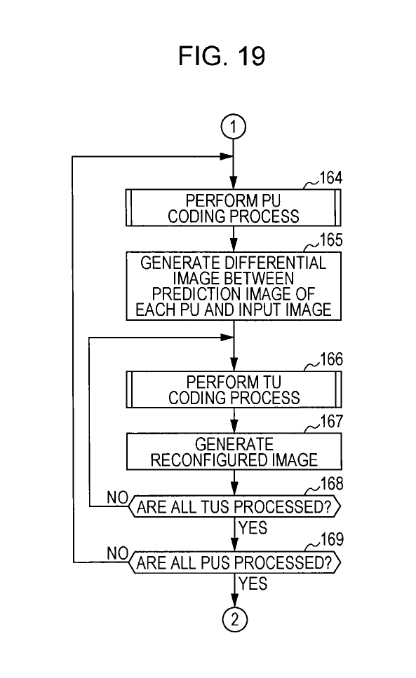

Subsequently, an example of the flow of a CU coding process will be described with reference to flowcharts in FIGS. 18 and 19.

In step S151, the motion search unit 151 performs motion search on a current CU. In step S152, the merging mode processing unit 121 performs a merging mode process.

In step S153, the cost function calculation unit 152 calculates the cost function of each intra prediction mode. In step S154, the mode determination unit 153 determines an optimal intra prediction mode based on the calculated cost function.

In step S155, the image coding apparatus 100 determines whether or not to perform division on the current CU. When it is determined to divide the current CU, the process proceeds to step S156.

In step S156, the reversible coding unit 106 codes that cu_split_flag=1, and includes the coded cu_split_flag=1 in the coded data (stream).

In step S157, the image coding apparatus 100 performs division on the current CU.

In step S158, the operation unit 103 to the reversible coding unit 106, the reverse quantization unit 108 to the operation unit 110, the selection unit 113 to the prediction image selection unit 116, and the merging mode processing unit 121 recursively performs the CU coding process on CUs obtained through the division. Further, when division is performed on the CU, the CU coding process is recursively performed on each of the CUs obtained through the division.

In step S159, with regard to the current CU, the image coding apparatus 100 determines whether or not all the CUs obtained through the division are coded. When it is determined that a non-processed CU is present, the process returns to step S158. When the process in step S158 is performed on all the CUs obtained through the division and it is determined that all the CUs obtained through the division are coded, the process returns to FIG. 17.

In addition, in step S155, when it is determined that division is not performed on the current CU, the process proceeds to step S160.

In step S160, the reversible coding unit 106 codes cu_split_flag=0, and includes the coded cu_split_flag=0 in the coded data (stream).

In step S161, the image coding apparatus 100 determines whether or not the optimal intra prediction mode of the current CU which is selected in step S154 is a merging mode. When it is determined that the optimal intra prediction mode is the merging mode, the process proceeds to step S162.

In step S162, the reversible coding unit 106 codes skip_flag=1 and identification information merge_idx, and includes the coded codes skip_flag=1 and the coded identification information merge_idx in the coded data (stream).

In step S163, the image coding apparatus 100 performs the CU merging mode coding process to code the current CU by performing the intra prediction on the current CU in the merging mode. When the process in step S163 is terminated, the process returns to FIG. 17.

In addition, when it is determined that the optimal intra prediction mode is not the merging mode in step S161, the process proceeds to FIG. 19.

In step S164 in FIG. 19, the reversible coding unit 106, the selection unit 113 to the prediction image selection unit 116, and the merging mode processing unit 121 perform the PU coding process to code a current PU which is the processing target of the current CU.

In step S165, the operation unit 103 generates a differential image between the prediction image of the current PU, which is generated by performing the process in step S164, and the input image.

In step S166, the orthogonal conversion unit 104 to the reversible coding unit 106, the reverse quantization unit 108, and the reverse orthogonal conversion unit 109 perform the TU coding process to code a current TU which is the processing target of the current CU.

In step S167, the operation unit 110 adds the differential image which is generated by performing the process in step S166 to the prediction image which is generated by performing the process in step S164, and generates a reconfigured image.

In step S168, the image coding apparatus 100 determines whether or not all the TUs in the current PU are processed. When it is determined that a non-processed TU is present, the process returns to step S166.

When each of the processes in steps S166 to S168 is performed on each TU and it is determined that all the TUs in the current PU are processed in step S168, the process proceeds to step S169.

In step S169, the image coding apparatus 100 determines whether or not all the PUs of the current CU are processed. When it is determined that a non-processed PU is present, the process returns to step S164.

When each of the processes in steps S164 to S169 is performed on each PU and it is determined that all the PUs in the current CU are processed in step S169, the process returns to FIG. 17.

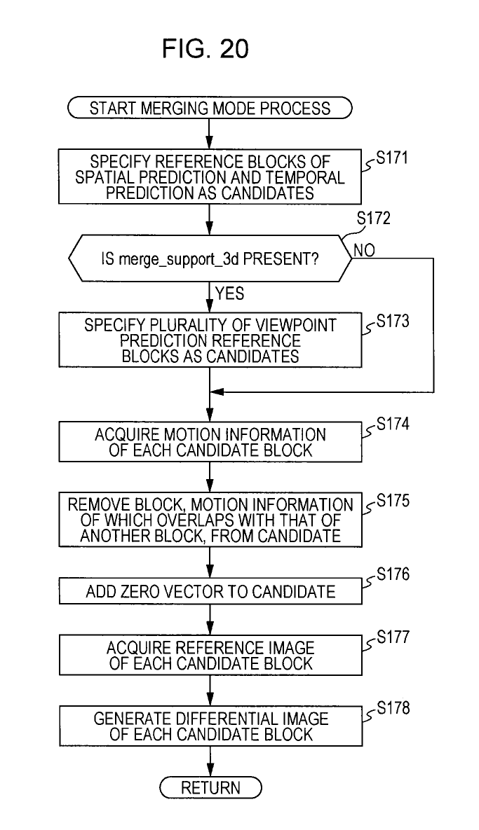

Subsequently, an example of the flow of a merging mode process which is performed in step S152 of FIG. 18 will be described with reference to a flowchart in FIG. 20.

In step S171, the candidate block specification unit 176 specifies the reference blocks of the spatial prediction and the temporal prediction as candidates, and sets the reference blocks to the candidate blocks.

In step S172, the viewpoint prediction reference block specification unit 175 and the candidate block specification unit 176 determine whether or not to include the neighbour block of the viewpoint direction in the candidate of the reference block in the merging mode. When it is determined to include the neighbour block of the viewpoint direction in the candidate of the reference block in the merging mode, the process proceeds to step S173.

In step S173, the viewpoint prediction reference block specification unit 175 specifies a plurality of viewpoint prediction reference blocks, and the candidate block specification unit 176 includes the plurality of viewpoint prediction reference blocks in the candidate block.

In step S174, the motion information acquisition unit 177 acquires the motion information of each candidate block. In step S175, the motion information acquisition unit 177 removes a block, the motion information of which overlaps with that of another block, from the candidate block. In step S176, the motion information acquisition unit 177 adds a zero vector to the candidate.

In step S177, the reference image acquisition unit 178 acquires a reference image corresponding to each piece of motion information. In step S178, the differential image generation unit 179 generates a differential image between each piece of reference information and the input image.

When the process in step S178 is terminated, the process returns to FIG. 18.

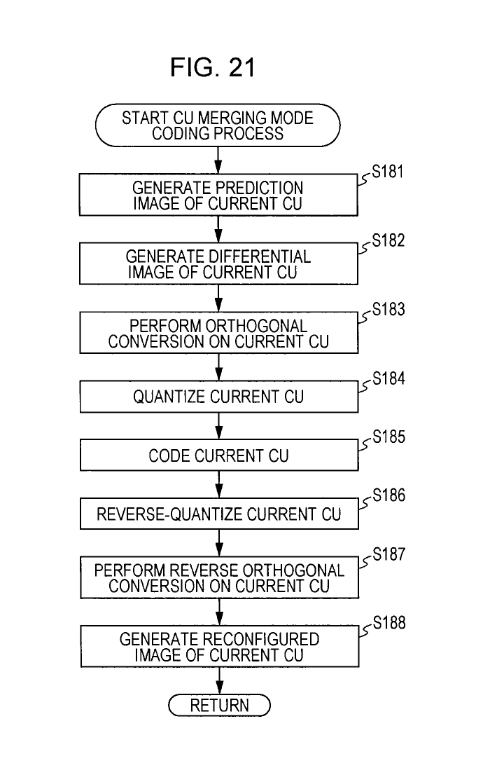

Subsequently, an example of the flow of a CU merging mode coding process which is performed in step S163 of FIG. 18 will be described with reference to a flowchart in FIG. 21.

In step S181, the motion compensation unit 154 generates the prediction image of the current CU. In step S182, the operation unit 103 generates the differential image of the current CU.

In step S183, the orthogonal conversion unit 104 performs orthogonal conversion on the differential image of the current CU. In step S184, the quantization unit 105 quantizes the orthogonal conversion coefficient of the current CU. In step S185, the reversible coding unit 106 codes the quantized orthogonal conversion coefficient of the current CU.

In step S186, the reverse quantization unit 108 reverse-quantizes the quantized orthogonal conversion coefficient of the current CU. In step S187, the reverse orthogonal conversion unit 109 performs reverse orthogonal conversion on the orthogonal conversion coefficient of the current CU which is acquired through the reverse quantization.

In step S188, the operation unit 110 adds the prediction image which is generated in step S181 to the differential image of the current CU which is acquired using the reverse orthogonal conversion, and generates a reconfigured image.

When the process in step S188 is terminated, the process returns to FIG. 18.

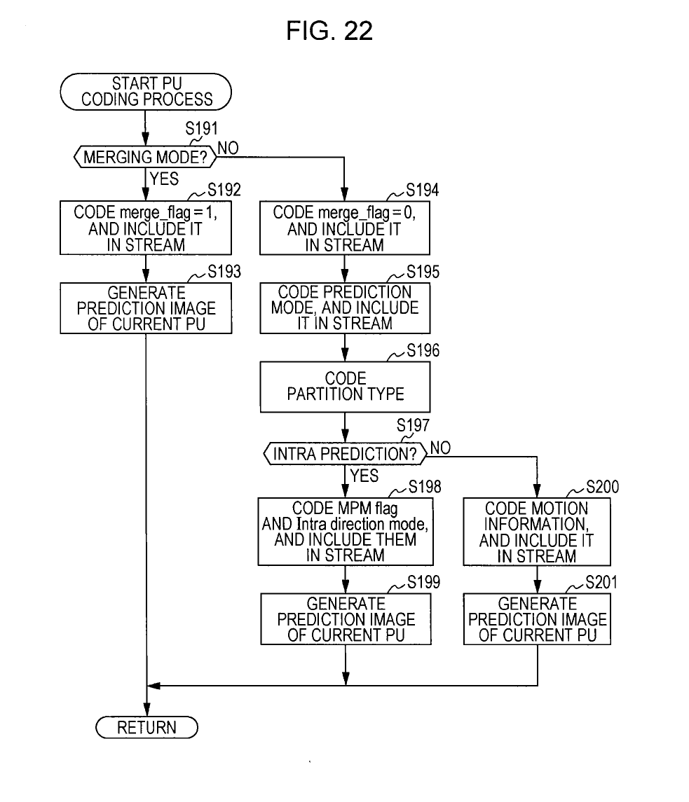

An example of the flow of the PU coding process which is performed in step S164 of FIG. 19 will be described with reference to a flowchart in FIG. 22.

In step S191, the image coding apparatus 100 determines whether or not a mode is the merging mode. When it is determined that the mode is the merging mode, the process proceeds to step S192.

In step S192, the reversible coding unit 106 codes merge_flag=1, and includes the coded merge_flag=1 in the coded data (stream).

In step S193, the motion compensation unit 154 generates the prediction image of the current PU. When the process in step S193 is terminated, the process returns to FIG. 19.

In addition, when it is determined that the mode is not the merging mode in step S191, the process proceeds to step S194.

In step S194, the reversible coding unit 106 codes merge_flag=0, and includes the coded merge_flag=0 in the coded data (stream). In step S195, the reversible coding unit 106 codes the prediction mode, and includes the coded prediction mode in the coded data (stream). In step S196, the reversible coding unit 106 codes a partition type.

In step S197, the prediction image selection unit 116 determines whether or not prediction is the intra prediction. When it is determined that the prediction is the intra prediction, the process proceeds to step S198.

In step S198, the reversible coding unit 106 codes an MPM flag and the Intra direction mode, and includes the coded MPM flag and the Intra direction mode in the coded stream.

In step S199, the intra prediction unit 114 generates the prediction image of the current PU. When the process in step S199 is terminated, the process returns to FIG. 19.

In addition, when it is determined that the prediction is not the intra prediction in step S197, the process proceeds to step S200.

In step S200, the reversible coding unit 106 codes the motion information, and includes the coded motion information in the coded data (stream).

In step S201, the motion compensation unit 154 generates the prediction image of the current PU. When the process in step S201 is terminated, the process returns to FIG. 19.

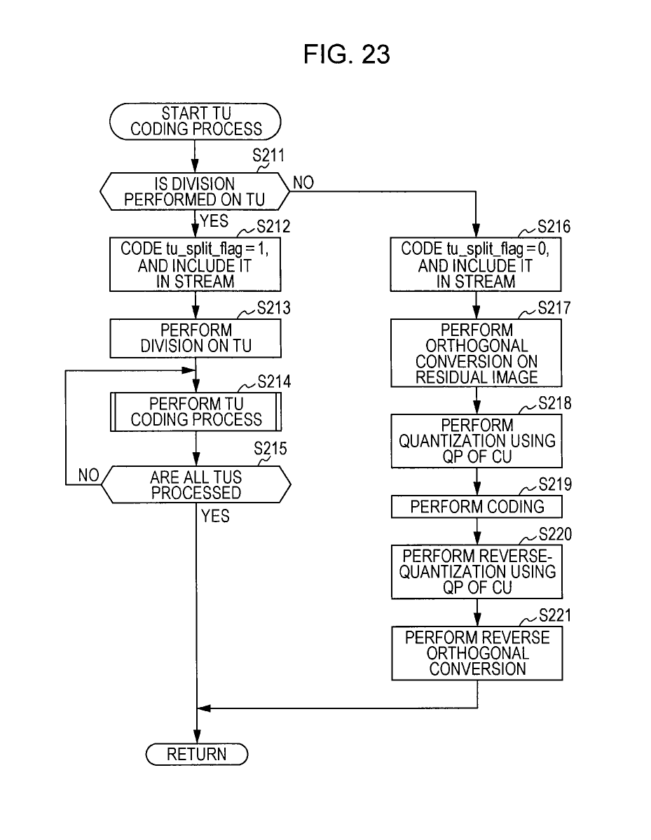

Subsequently, an example of the flow of a TU coding process which is performed in step S166 of FIG. 19 will be described with reference to a flowchart in FIG. 23.

In step S211, the image coding apparatus 100 determines whether or not to perform division on the current TU. When it is determined to perform division on the current TU, the process proceeds to step S212.

In step S212, the reversible coding unit 106 codes tu_split_flag=1, and includes the coded tu_split_flag=1 in the coded data (stream).

In step S213, the image coding apparatus 100 performs division on the current TU. In step S214, the orthogonal conversion unit 104 to the reversible coding unit 106, the reverse quantization unit 108, and the reverse orthogonal conversion unit 109 recursively performs the TU coding process on each TU obtained through the division.

In step S215, the image coding apparatus 100 determines whether or not all the TUs, which are obtained by performing division on the current TU, are processed. When a non-processed TU is present, the process returns to step S214. In addition, when it is determined that the TU coding process is performed on all the TUs in step S215, the process returns to FIG. 19.

In addition, when it is determined not to perform division on the current TU in step S211, the process proceeds to step S216.

In step S216, the reversible coding unit 106 codes tu_split_flag=0, and includes the coded tu_split_flag=0 in the coded data (stream).

In step S217, the orthogonal conversion unit 104 performs the orthogonal conversion on the differential image (residual image) of the current TU. In step S218, the quantization unit 105 quantizes the orthogonal conversion coefficient of the current TU using the quantization parameter QP of the current CU.

In step S219, the reversible coding unit 106 codes the quantized orthogonal conversion coefficient of the current TU.

In step S220, the reverse quantization unit 108 reverse quantizes the quantized orthogonal conversion coefficient of the current TU using the quantization parameter QP of the current CU. In step S221, the reverse orthogonal conversion unit 109 performs reverse orthogonal conversion on the orthogonal conversion coefficient of the current TU which is acquired by performing reverse-quantization.

When the process in step S221 is terminated, the process returns to FIG. 19.

The image coding apparatus 100 can set a plurality of neighbour blocks in the viewpoint direction as the candidates of the reference block in the merging mode by performing each of the above-described processes. Therefore, the image coding apparatus 100 improves the prediction accuracy, and thus it is possible to improve coding efficiency.

### 2. Second Embodiment

### 2-1. Image Decoding Apparatus

FIG. 24 is a block diagram illustrating an example of the main configuration of the image decoding apparatus which is the image processing apparatus to which the present technology is applied. An image decoding apparatus 300 shown in FIG. 24 corresponds to the above-described image coding apparatus 100, correctly decodes the bit stream (the coded data) which is generated in such a way that the image coding apparatus 100 codes the image data, and generates a decoded image. That is, the image decoding apparatus 300 decodes the coded data on which field coding will be performed and which is obtained by coding an image having an interlace format in which resolution in the vertical direction differs between a brightness signal and a color difference signal.

The image decoding apparatus 300 shown in FIG. 24 includes a storage buffer 301, a reversible decoding unit 302, a reverse quantization unit 303, a reverse orthogonal conversion unit 304, an operation unit 305, a loop filter 306, a screen sorting buffer 307, and a D/A conversion unit 308. In addition, the image decoding apparatus 300 includes a frame memory 309, a selection unit 310, an intra prediction unit 311, a motion prediction/compensation unit 312, and a selection unit 313.

The storage buffer 301 accumulates the transmitted coded data, and supplies the coded data to the reversible decoding unit 302 in a predetermined timing. The reversible decoding unit 302 decodes information which is supplied from the storage buffer 301 and coded by the reversible coding unit 106 in FIG. 8 using a method corresponding to the coding method of the reversible coding unit 106. The reversible decoding unit 302 supplies the quantized coefficient data of the differential image, which is acquired through decoding, to the reverse quantization unit 303.

In addition, the reversible decoding unit 302 determines whether the intra prediction mode or the inter prediction mode is selected as the optimal prediction mode with reference to the information which is acquired by decoding the coded data and relates to the optimal prediction mode. That is, the reversible decoding unit 302 determines whether the prediction mode which is used in the transmitted coded data is the intra prediction or the inter prediction.

The reversible decoding unit 302 supplies the information which relates to the prediction mode to the intra prediction unit 311 or the motion prediction/compensation unit 312 based on the result of the determination. For example, when the intra prediction mode is selected as the optimal prediction mode in the image coding apparatus 100, the reversible decoding unit 302 supplies intra prediction information which is supplied from the coding side and indicates the information which relates to the selected intra prediction mode to the intra prediction unit 311. In addition, for example, when the inter prediction mode is selected as the optimal prediction mode in the image coding apparatus 100, the reversible decoding unit 302 supplies inter prediction information which is supplied from the coding side and indicates the information which relates to the selected inter prediction mode to the motion prediction/compensation unit 312.

The reverse quantization unit 303 reverse quantizes the quantized coefficient data which is decoded and acquired by the reversible decoding unit 302 using a method corresponding to the quantization method of the quantization unit 105 in FIG. 8 (using the same method as that of the reverse quantization unit 108). The reverse quantization unit 303 supplies the reverse quantized coefficient data to the reverse orthogonal conversion unit 304.

The reverse orthogonal conversion unit 304 performs the reverse orthogonal conversion on the coefficient data which is supplied from the reverse quantization unit 303 using a method corresponding to the orthogonal conversion method of the orthogonal conversion unit 104 in FIG. 8. The reverse orthogonal conversion unit 304 acquires the differential image which corresponds to the differential image obtained before the orthogonal conversion is performed in the image coding apparatus 100 using the reverse orthogonal conversion.

The differential image obtained by performing the reverse orthogonal conversion is supplied to the operation unit 305. In addition, the prediction image is supplied to the operation unit 305 from the intra prediction unit 311 or the motion prediction/compensation unit 312 via the selection unit 313.

The operation unit 305 adds the differential image to the prediction image, and acquires the reconfigured image which corresponds to an image obtained before the prediction image is subtracted by the operation unit 103 of the image coding apparatus 100. The operation unit 305 supplies the reconfigured image to the loop filter 306.

The loop filter 306 generates a decoded image by appropriately performing a loop filter process which includes the deblocking filter process and the adaptive loop filter process on the supplied reconfigured image. For example, the loop filter 306 removes block distortion by performing the deblocking filter process on the reconfigured image. In addition, for example, the loop filter 306 improves image quality by performing the loop filter process on the result of the deblocking filter process (a reconfigured image from which block distortion is removed) using the Wiener filter.

Meanwhile, an arbitrary type of filter process is performed by the loop filter 306, and other filter processes may be performed in addition to the above-described filter process. In addition, the loop filter 306 may perform the filter process using the filter coefficient which is supplied from the image coding apparatus 100 in FIG. 8.

The loop filter 306 supplies the decoded image which is the result of the filter process to the screen sorting buffer 307 and the frame memory 309. Meanwhile, the filter process which is performed by the loop filter 306 can be omitted. That is, it is possible to store the output from the operation unit 305 in the frame memory 309 without performing the filter process thereon. For example, the intra prediction unit 311 uses the pixel value of a pixel included in the image as the pixel value of a neighbour pixel.

The screen sorting buffer 307 sorts the supplied decoded images. That is, the orders of frames, which are sorted for the order of coding by the screen sorting buffer 102 in FIG. 8, are sorted in the order of original display. The D/A conversion unit 308 performs D/A conversion on the decoded image which is supplied from the screen sorting buffer 307, and outputs and displays the decoded image obtained through the D/A conversion to a display which is not shown in the drawing.

The frame memory 309 stores the supplied reconfigured image and the decoded image. In addition, the frame memory 309 supplies the stored reconfigured image and the decoded image to the intra prediction unit 311 and the motion prediction/compensation unit 312 via the selection unit 310 in a predetermined timing or based on the request from the outside, such as the intra prediction unit 311 and the motion prediction/compensation unit 312.

The intra prediction unit 311 performs basically the same process as the intra prediction unit 114 in FIG. 8. However, the intra prediction unit 311 performs the intra prediction on only an area in which a prediction image is generated through the intra prediction when coding is performed.

The motion prediction/compensation unit 312 generates a prediction image by performing the inter prediction (including the motion prediction and the motion compensation) on inter prediction information which is supplied from the reversible decoding unit 302. Meanwhile, the motion prediction/compensation unit 312 performs the inter prediction on only an area in which the inter prediction is performed when coding is performed based on the inter prediction information which is supplied from the reversible decoding unit 302.

The intra prediction unit 311 and the motion prediction/compensation unit 312 supply the generated prediction image to the operation unit 305 via the selection unit 313 for each area in units of a prediction process.

The selection unit 313 supplies the prediction image which is supplied from the intra prediction unit 311 or the prediction image which is supplied from the motion prediction/compensation unit 312 to the operation unit 305.

The image decoding apparatus 300 further includes a merging mode processing unit 321.

The reversible decoding unit 302 supplies information which relates to the merging mode, for example, the flag information (including merge_support_{—}3d_flag, MergeFlag, and MergeLeftFlag), the viewpoint prediction information (including length_from_col0 and length_from_col1), and information indicative of a reference block which refers to the motion information (including identification information merge_idx) which are transmitted from image coding apparatus 100, to the merging mode processing unit 321.

The merging mode processing unit 321 generates (reconfigures) the motion information of the current block using the supplied information. The merging mode processing unit 321 supplies the generated motion information to the motion prediction/compensation unit 312.

### 2-2. Merging Mode Processing Unit

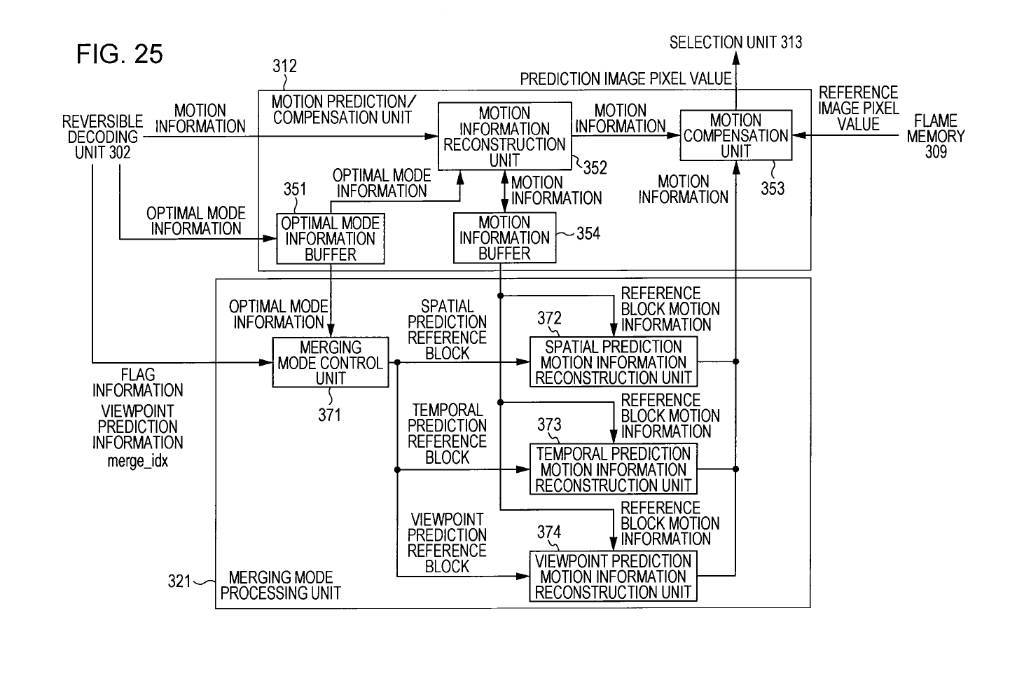

FIG. 25 is a block diagram illustrating an example of the main configuration of the merging mode processing unit.

As shown in FIG. 25, the motion prediction/compensation unit 312 includes an optimal mode information buffer 351, a motion information reconstruction unit 352, a motion compensation unit 353, and a motion information buffer 354.

In addition, the merging mode processing unit 321 includes a merging mode control unit 371, a spatial prediction motion information reconstruction unit 372, a temporal prediction motion information reconstruction unit 373, and a viewpoint prediction motion information reconstruction unit 374.

The optimal mode information buffer 351 acquires the optimal mode information which is supplied from the reversible decoding unit 302. When the optimal mode is not the merging mode, the optimal mode information buffer 351 supplies the optimal mode information to the motion information reconstruction unit 352. In addition, when the optimal mode is the merging mode, the optimal mode information buffer 351 supplies the optimal mode information to the merging mode control unit 371.

The motion information reconstruction unit 352 generates (reconstructs) the motion information of the current block using the motion information which is supplied from the reversible decoding unit 302. For example, when the differential motion information between the motion information of the current block and the prediction motion information of the current block is supplied from the reversible decoding unit 302, the motion information reconstruction unit 352 acquires the decoded motion information of the neighbour block from the motion information buffer 354. The motion information reconstruction unit 352 generates the prediction motion information of the current block using the motion information. Thereafter, the motion information reconstruction unit 352 generates (reconstructs) the motion information of the current block by adding the prediction motion information to the differential motion information. The motion information reconstruction unit 352 supplies the generated motion information to the motion compensation unit 353. In addition, the motion information reconstruction unit 352 supplies the generated motion information to the motion information buffer 354.

When the optimal mode is not the merging mode, the motion compensation unit 353 acquires a reference image corresponding to the motion information, which is supplied from the motion information reconstruction unit 352, from the frame memory 309. In addition, when the optimal mode is the merging mode, the motion compensation unit 353 acquires the motion information which is supplied from the spatial prediction motion information reconstruction unit 372, the temporal prediction motion information reconstruction unit 373, or the viewpoint prediction motion information reconstruction unit 374. The motion compensation unit 353 acquires the reference image corresponding to the acquired motion information from the frame memory 309, and sets the reference image to the prediction image. The motion compensation unit 353 supplies the prediction image pixel value to the selection unit 313.

The motion information buffer 354 stores the motion information which is supplied from the motion information reconstruction unit 352. The motion information buffer 354 supplies the stored motion information, as the motion information of the neighbour block, to the motion information reconstruction unit 352, the spatial prediction motion information reconstruction unit 372, the temporal prediction motion information reconstruction unit 373, and the viewpoint prediction motion information reconstruction unit 374.

In the case of the merging mode, the merging mode control unit 371 acquires information which is supplied from the reversible decoding unit 302 and relates to the merging mode, specifies the prediction direction of the reference block based on the information, and generates (reconstructs) motion information by controlling the spatial prediction motion information reconstruction unit 372, the temporal prediction motion information reconstruction unit 373, and the viewpoint prediction motion information reconstruction unit 374.

For example, when merge_support_{—}3D flag=1 and the neighbour block in the viewpoint direction is designated as the reference block using the identification information merge_idx, the merging mode control unit 371 specifies a viewpoint prediction reference block using the viewpoint prediction information. The merging mode control unit 371 supplies information which indicates the specified viewpoint prediction reference block to the viewpoint prediction motion information reconstruction unit 374.

In addition, for example, when the neighbour block in the time direction is designated as the reference block using the identification information merge_idx, the merging mode control unit 371 specifies a temporal prediction reference block. The merging mode control unit 371 supplies information which indicates the specified temporal prediction reference block to the temporal prediction motion information reconstruction unit 373.

In addition, for example, when the neighbour block in the spatial direction is designated as the reference block using the identification information merge_idx, the merging mode control unit 371 specifies a spatial prediction reference block. The merging mode control unit 371 supplies information which indicates the specified spatial prediction reference block to the spatial prediction motion information reconstruction unit 372.

The spatial prediction motion information reconstruction unit 372 acquires the motion information of the specified spatial prediction reference block from the motion information buffer 354, and supplies the motion information to the motion compensation unit 353 as the motion information of the current block.

In addition, the temporal prediction motion information reconstruction unit 373 acquires the motion information of the specified temporal prediction reference block from the motion information buffer 354, and supplies the motion information to the motion compensation unit 353 as the motion information of the current block.

Further, the viewpoint prediction motion information reconstruction unit 374 acquires the motion information of the specified viewpoint prediction reference block from the motion information buffer 354, and supplies the motion information to the motion compensation unit 353 as the motion information of the current block.

As described above, merging mode control unit 371 generates (reconstructs) the motion information of the current block using information which is supplied from the image coding apparatus 100 and relates to the merging mode (identification information merge_idx, merge_support_{—}3d_flag, length_from_col0, and length_from_col1). Therefore, the image decoding apparatus 300 can appropriately decodes the coded data which is coded in the merging mode using the reference block which is supplied from the image coding apparatus 100 and selected from among candidates including the plurality of neighbour blocks in the time direction. Therefore, the image decoding apparatus 300 can implement an improvement in coding efficiency.

### 2-3. Flow of Process

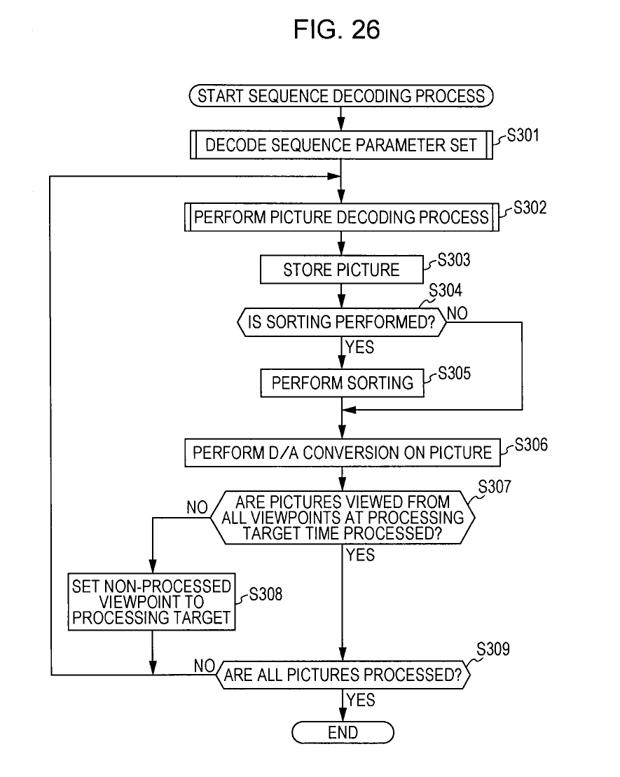

Subsequently, the flow of each process which is performed by the above-described image decoding apparatus 300 will be described. First, an example of the flow of a sequence decoding process will be described with reference to a flowchart in FIG. 26.

When the storage buffer 301 acquires coded data, the reversible decoding unit 302 decodes a sequence parameter set in step S301.

In step S302, the reversible decoding unit 302 to the loop filter 306, the frame memory 309 to the selection unit 313, and the merging mode processing unit 321 performs a picture decoding process to decode the coded data of a current picture which is a processing target.

In step S303, the screen sorting buffer 307 stores the image data of the current picture which is acquired in such a way as to decode the coded data using the process in step S302.

In step S304, the screen sorting buffer 307 determines whether or not to sort pictures. When it is determined to performing sorting, the process proceeds to step S305.

In step S305, the screen sorting buffer 307 sorts the pictures. When the process in step S305 is terminated, the process proceeds to step S306. In addition, in step S304, when it is determined not to perform sorting, the process proceeds to step S306.

In step S306, the D/A conversion unit 308 performs D/A conversion on the image data of the picture. In step S307, the image decoding apparatus 300 determines whether or not pictures viewed from all the viewpoints are processed at a processing target time. When it is determined that a non-processed viewpoint is present, the process proceeds to step S308.

In step S308, the image decoding apparatus 300 sets a picture viewed from a non-processed viewpoint (view) at the processing target time to a processing target (current picture). When the process in step S308 is terminated, the process returns to step S302.

As described above, each of the processes in steps S302 to step S308 is performed on a picture of each view. Therefore, the pictures of all the viewpoints are decoded. In step S307, when it is determined that pictures viewed from all the viewpoints (views) are processed at the processing target time, the process proceeds to step S309. Therefore, the processing target is updated using a subsequent time (a subsequent picture).

In step S309, the image decoding apparatus 300 determines whether all the pictures in a sequence are processed. When it is determined that a non-processed picture is present in the sequence, the process returns to step S302. That is, each of the processes in step S302 to step S309 is repeatedly performed, with the result that the pictures of all the views are coded each time, and thus all the pictures in the sequence are finally decoded.

When it is determined that all the pictures are processed in step S309, the sequence decoding process is terminated.

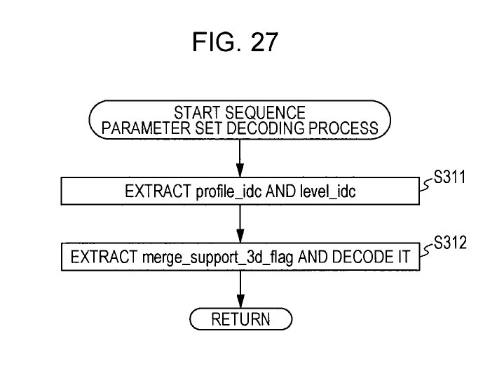

Subsequently, an example of the flow of a sequence parameter set decoding process which is performed in step S301 in FIG. 26 will be described with reference to a flowchart in FIG. 27.

In step S311, the reversible decoding unit 302 extracts profile_idc and lvel_idc from the sequence parameter set of the coded data.

In step S312, the reversible decoding unit 302 extracts merge_support_{—}3d_flag from the sequence parameter set of the coded data, and decodes the merge_support_{—}3d_flag. Since the merge_support_{—}3d_flag which is included in the sequence parameter set is read and used as described above, the image decoding apparatus 300 can cause the number of candidates of the reference block to be variable, and can implement the suppression of increase in the coding amount of the identification information merge_idx.

When the process in step S312 is terminated, the process returns to FIG. 26.

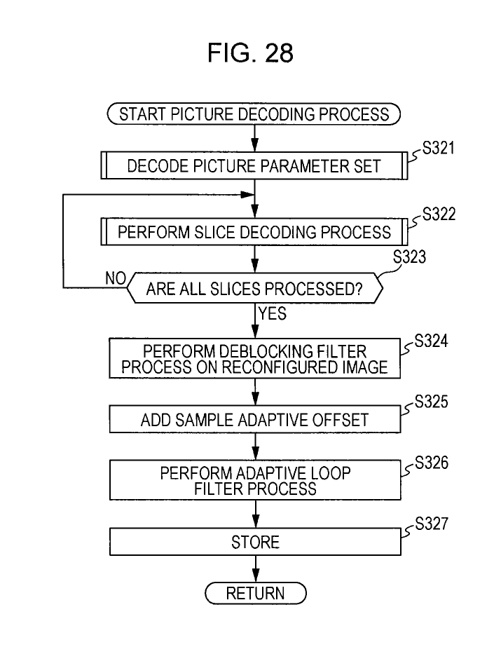

Subsequently, an example of the flow of a picture decoding process which is performed in step S302 in FIG. 26 will be described with reference to a flowchart in FIG. 28.

In step S321, the reversible decoding unit 302 performs a picture parameter set decoding process to decode the picture parameter set.

In step S322, the reversible decoding unit 302 to the operation unit 305, the selection unit 310 to the selection unit 313, and the merging mode processing unit 321 perform a slice decoding process to decode the coded data of a current slice which is a processing target of the current picture.

In step S323, the image decoding apparatus 300 determines whether or not all the slices of the current picture are processed. When it is determined that a non-processed slice is present in the current picture, the process returns to step S322. That is, the process in step S322 is performed on each of the slices of the current picture.

When it is determined that the coded data of all the slices in the current picture are decoded in step S323, the process proceeds to step S324.

In step S324, the loop filter 306 performs a deblocking filter process on the reconfigured image which is acquired by performing the process in step S322. In step S325, the loop filter 306 adds sample adaptive offset. In step S326, the loop filter 306 performs an adaptive loop filter process.

In step S327, the frame memory 309 stores the image data (the decoded image) of the current picture obtained through the filter process as described above.

When the process in step S327 is terminated, the process returns to FIG. 26.

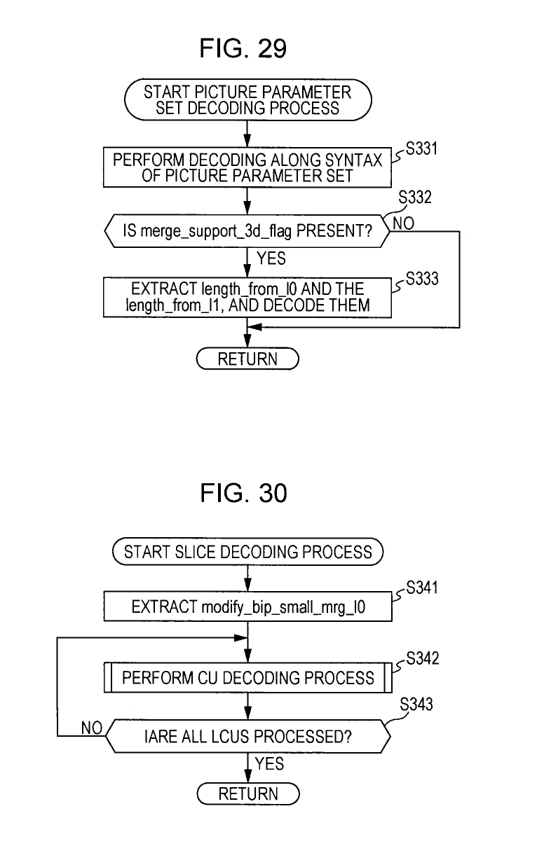

Subsequently, an example of the flow of the picture parameter set decoding process which is performed in step S321 in FIG. 28 will be described with reference to a flowchart in FIG. 29.

In step S331, the reversible decoding unit 302 performs decoding along the syntax of the picture parameter set.

In step S332, the reversible decoding unit 302 determines whether or not to include the neighbour block in the viewpoint direction in the candidate of the reference block in the merging mode based on the value of the merge_support_{—}3d_flag extracted from the sequence parameter set. When it is determined that the viewpoint prediction is used as one of the candidates in the merging mode, the process proceeds to step S333.

In step S333, the reversible decoding unit 302 extracts the viewpoint prediction information (including, for example, length_from_col0 and length_from_col1) from the picture parameter set, and decodes the viewpoint prediction information. When the process in step S333 is terminated, the process returns to FIG. 28.

In addition, when it is determined that the merge_support_{—}3d_flag is not present or when it is determined not to include the neighbour block in the viewpoint direction in the candidate of the reference block in the merging mode in step S332, the process returns to FIG. 28.

Subsequently, an example of the flow of the slice decoding process which is performed in step S322 in FIG. 28 will be described with reference to a flowchart in FIG. 30.

In step S341, the reversible decoding unit 302 extracts modify_bip_small_mrg_{—}10 from the slice header of the coded data.

In step S342, the reversible decoding unit 302 to the operation unit 305, the selection unit 310 to the selection unit 313, and the merging mode processing unit 321 performs a CU decoding process to decode the coded data of a current CU which is the processing target of a current slice.

In step S343, the image decoding apparatus 300 determines whether or not the coded data of all the LCUs of the current slice are decoded. When it is determined that a non-processed LCU is present, the process returns to step S342. That is, the process in step S342 is performed on all the CUs (LCUs) of the current slice.

In step S343, when it is determined that the coded data of all the LCUs are decoded, the process returns to FIG. 28.

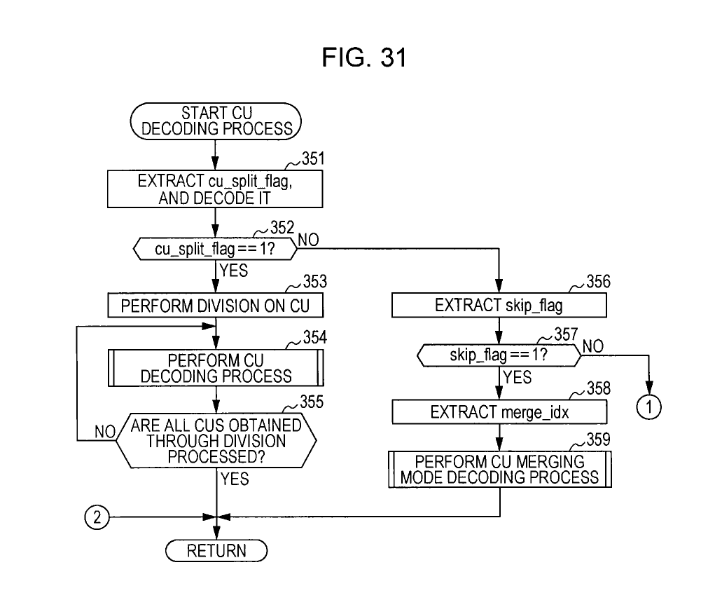

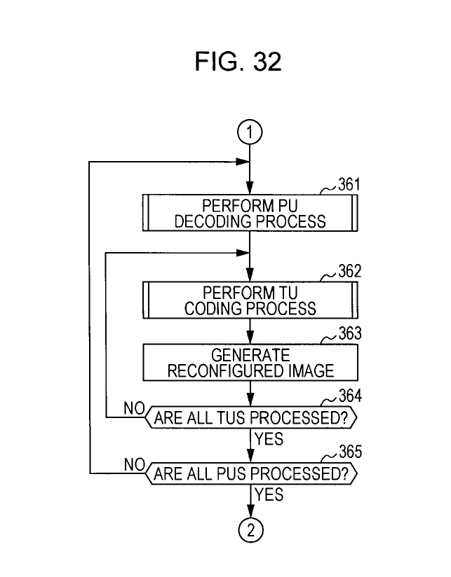

Subsequently, an example of the flow of a CU decoding process which is performed in step S342 in FIG. 30 will be described with reference to flowcharts in FIGS. 31 and 32.

In step S351, the reversible decoding unit 302 extracts flag information cu_split_flag from the coded data of the current CU, and decodes the flag information cu_split_flag.

In step S352, the image decoding apparatus 300 determines whether or not the value of the cu_split_flag is 1. When it is determined that the value of the cu_split_flag is 1 which is a value meaning that division should be performed on the CU, the process proceeds to step S353.

In step S353, the image decoding apparatus 300 performs division on the current CU. In step S354, the reversible decoding unit 302 to the operation unit 305, the selection unit 310 to the selection unit 313, and the merging mode processing unit 321 recursively performs a CU decoding process on CUs obtained through the division.

In step S355, the image decoding apparatus 300 determines whether or not all the CUs obtained by performing division on the current CU are processed. When it is determined that a non-processed CU is present, the process returns to step S354. That is, the CU decoding process is recursively performed on all the CUs obtained by performing division on the current CU.

When all the CUs are processed in step S355, the process returns to FIG. 30.

In addition, when it is determined that the value of the cu_split_flag is 0 meaning that division should not be performed anymore on the current CU in step S352, the process proceeds to step S356.

In step S356, the reversible decoding unit 302 extracts flag information skip_flag from the coded data of the current CU.

In step S357, the image decoding apparatus 300 determines whether or not the value of the flag information skip_flag is 1. When it is determined that the value of the skip_flag is 1 which is a value indicative of a skip mode, the process proceeds to step S358.

In step S358, the reversible decoding unit 302 extracts the identification information merge_idx from the coded data of the current CU.

In step S359, the reverse quantization unit 303 to the operation unit 305, the motion prediction/compensation unit 312, the selection unit 313, and the merging mode processing unit 321 perform a CU merging mode decoding process to decode the coded data of the current CU in the merging mode.

When the process inn step S359 is terminated, the process returns to FIG. 30.

In addition, in step S357, when it is determined that the value of the skip_flag is 0 meaning that a mode is not the skip mode, the process proceeds to FIG. 32.

In step S361 in FIG. 32, the reversible decoding unit 302 to the reverse orthogonal conversion unit 304, the selection unit 310 to the selection unit 313, and the merging mode processing unit 321 performs a PU decoding process to decode the coded data of a current PU which is the processing target of the current CU.

In step S362, the reversible decoding unit 302 to the reverse orthogonal conversion unit 304, the selection unit 310 to the selection unit 313, and the merging mode processing unit 321 performs a TU decoding process to decode the coded data of a current TU which is the processing target of the current PU.

In step S363, the operation unit 305 generates a reconfigured image by adding the differential image of the current TU which is acquired by performing the process in step S362 to a prediction image.

In step S364, the image decoding apparatus 300 determines whether or not the coded data of all the TUs in the current PU are decoded. When it is determined that a non-processed TU is present, the process returns to step S362. That is, each of the processes in steps S362 and S363 is performed on all the TUs of the current PU.

In addition, when it is determined that all the TUs are processed in step S364, the process proceeds to step S365.

In step S365, the image decoding apparatus 300 determines whether or not the coded data of all the PUs in the current CU are decoded. When it is determined that a non-processed PU is present, the process returns to step S361. That is, each of the processes in steps S361 to S365 is performed on all the PUs of the current CU.

In addition, when it is determined that all the PUs are processed in step S365, the process returns to FIG. 30.

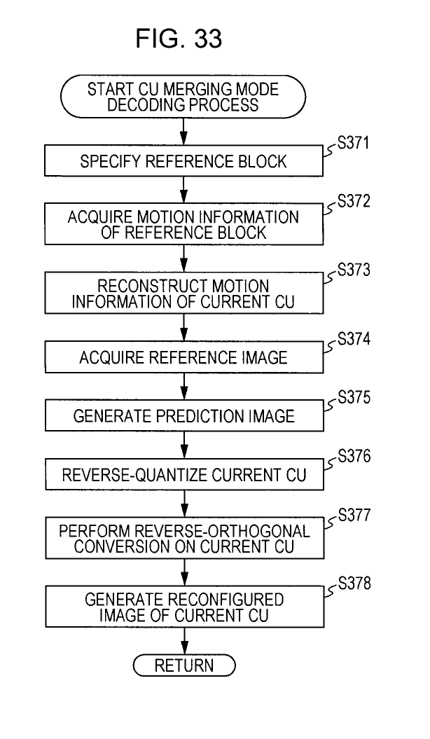

Subsequently, an example of the flow of the CU merging mode decoding process which is performed in step S359 in FIG. 31 will be described with reference to a flowchart in FIG. 33.

In step S371, the merging mode control unit 371 specifies a reference block based on the flag information, the identification information merge_idx, and the viewpoint prediction information.

In step S372, any one of the spatial prediction motion information reconstruction unit 372 to the viewpoint prediction motion information reconstruction unit 374, which are controlled by the merging mode control unit 371, acquires the motion information of the reference block from the motion information buffer 354.

In step S373, any one of the spatial prediction motion information reconstruction unit 372 to the viewpoint prediction motion information reconstruction unit 374, which are controlled by the merging mode control unit 371, generates (reconstructs) the motion information of the current CU using the motion information which is acquired in step S372.

In step S374, the motion compensation unit 353 acquires a reference image corresponding to the motion information, which is generated (reconstructed) in step S373, from the frame memory 309 via the selection unit 310.

In step S375, the motion compensation unit 353 generates the prediction image of the current CU using the reference image which is acquired in step S374.

In step S376, the reversible decoding unit 302 decodes the coded data of the current CU. The reverse quantization unit 303 reverse quantizes the quantized orthogonal conversion coefficient of the differential image which is acquired through decoding.

In step S377, the reverse orthogonal conversion unit 304 performs the reverse orthogonal conversion on the orthogonal conversion coefficient of the differential image which is acquired through the reverse quantization in step S376.

In step S378, the operation unit 305 generates the reconfigured image of the current CU by adding the prediction image, which is generated by performing the process in step S375, to the image data of the differential image which is acquired by performing the reverse orthogonal conversion in step S377.

When the process in step S378 is terminated, the process returns to FIG. 30.

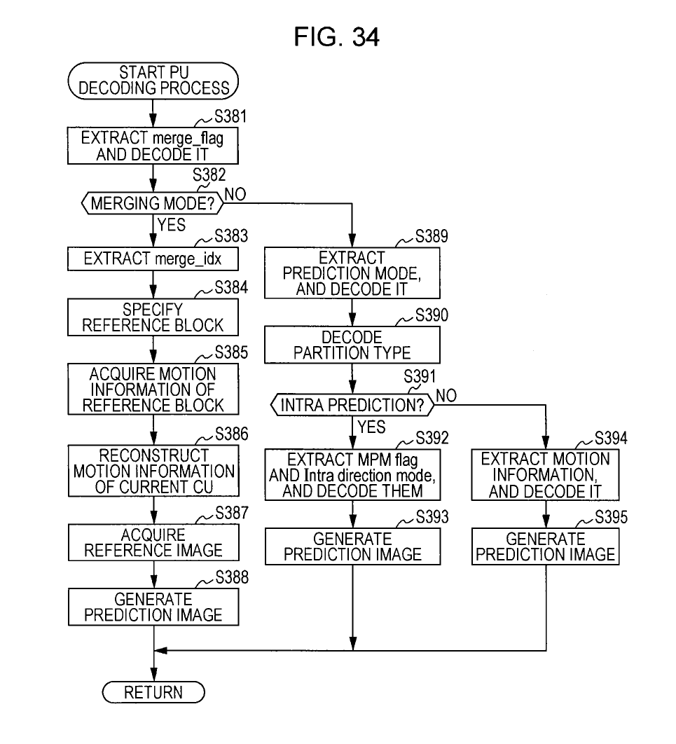

Subsequently, an example of the flow of a PU decoding process which is performed in step S361 in FIG. 32 will be described with reference to a flowchart in FIG. 34.

In step S381, the reversible decoding unit 302 extracts the flag information merge_flag from the coded data of the current PU, and decodes the flag information merge_flag.

In step S382, the image decoding apparatus 300 determines whether or not the prediction mode of the current PU is the merging mode based on the value of the flag information merge_flag. When it is determined to be the merging mode, the process proceeds to step S383.

In step S383, the reversible decoding unit 302 extracts the flag information merge_idx from the coded data of the current PU.

In step S384, the merging mode control unit 371 specifies the reference block based on the flag information, the identification information merge_idx, and the viewpoint prediction information.

In step S385, any of the spatial prediction motion information reconstruction unit 372 to the viewpoint prediction motion information reconstruction unit 374, which are controlled by the merging mode control unit 371, acquires the motion information of the reference block from the motion information buffer 354.

In step S386, any of the spatial prediction motion information reconstruction unit 372 to the viewpoint prediction motion information reconstruction unit 374, which are controlled by the merging mode control unit 371, generates (reconstructs) the motion information of the current PU using the motion information which is acquired in step S385.

In step S387, the motion compensation unit 353 acquires the reference image corresponding to the motion information which is generated (reconstructed) in step S386 from the frame memory 309 via the selection unit 310.

In step S388, the motion compensation unit 353 generates the prediction image of the current PU using the reference image which is acquired in step S387.

When the process in step S386 is terminated, the process returns to FIG. 32.

In addition, when it is determined that the mode is not the merging mode in step S382, the process proceeds to step S389.

In step S389, the reversible decoding unit 302 extracts the optimal mode information from the coded data, and decodes the optimal mode information. In step S390, the reversible decoding unit 302 decodes a partition type.

In step S391, the image decoding apparatus 300 determines whether or not the prediction mode of the current PU is the intra prediction based on the optimal prediction mode. When it is determined that the prediction mode is the intra prediction, the process proceeds to step S392.

In step S392, the reversible decoding unit 302 extracts an MPM flag and an Intra direction mode from the coded data, and decodes the MPM flag and the Intra direction mode.

In step S393, the intra prediction unit 311 generates the prediction image of the current PU using the information which is decoded in step S392.

When the process in step S393 is terminated, the process returns to FIG. 32.

In addition, when it is determined that the prediction mode is the inter prediction in step S391, the process proceeds to step S394.

In step S394, the reversible decoding unit 302 extracts motion information from the coded data, and decodes the motion information.

In step S395, the motion information reconstruction unit 352 generates (reconstructs) the motion information of the current PU using the motion information which is extracted in step S394. The motion compensation unit 353 generates the prediction image of the current PU using the generated motion information of the current PU.

When the process in step S395 is terminated, the process returns to FIG. 32.

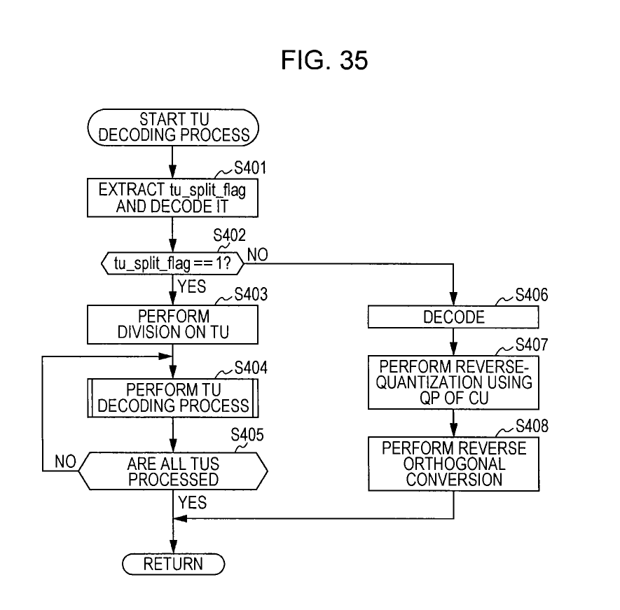

Subsequently, an example of the flow of a TU decoding process which is performed in step S362 in FIG. 32 will be described with reference to a flowchart in FIG. 35.

In step S401, the reversible decoding unit 302 extracts flag information tu_split_flag from the coded data, and decodes the flag information tu_split_flag.

In step S402, the image decoding apparatus 300 determines whether or not the value of the flag information tu_split_flag is 1 meaning that division should be performed on the TU. When it is determined that the value of the flag information tu_split_flag is 1, the process proceeds to step S403.

In step S403, the image decoding apparatus 300 performs division on the current TU.

In step S404, the reversible decoding unit 302 to the reverse orthogonal conversion unit 304, the selection unit 310 to the selection unit 313, and the merging mode processing unit 321 recursively performs the TU decoding process on each of the TUs which are acquired by performing division on the current TU. That is, the image decoding apparatus 300 determines whether or not all the TUs which are acquired by performing division on the current TU are processed in step S405. Thereafter, when it is determined that a non-processed TU is present, the process returns to step S404. As described above, the TU decoding process in step S404 is performed on all the TUs which are acquired by performing division on the current TU. When it is determined that all the TUs are processed in step S405, the process returns to FIG. 32.

In addition, when it is determined that the value of the flag information tu_split_flag is 0 meaning that division is not performed anymore on the current TU in step S402, the process proceeds to step S406.

In step S406, the reversible decoding unit 302 decodes the coded data of the current TU.

In step S407, the reverse quantization unit 303 reverse quantizes the quantized orthogonal conversion coefficient of the differential image of the current TU which is acquired by performing the process in step S406 using the quantization parameter (QP) of the current CU.

In step S408, the reverse orthogonal conversion unit 304 performs reverse orthogonal conversion on the orthogonal conversion coefficient of the differential image of the current TU which is acquired by performing the process in step S407.

When the process in step S408 is terminated, the process returns to FIG. 32.

The image decoding apparatus 300 can appropriately decode the coded data which is coded using the merging mode which uses the reference block selected from among the candidates which include the plurality of neighbour blocks in the time direction which are provided from the image coding apparatus 100 by performing each of the processes as described above. Therefore, the image decoding apparatus 300 can implement the improvement in coding efficiency.

### 3. Third Embodiment

### The Others

Meanwhile, a plurality of neighbour blocks in the viewpoint direction, which are the candidates of the reference block in the merging mode, may be used, and three or more neighbour blocks may be used. In addition, the respective candidates may be provided in a plurality of directions with regard to a co-located block, and each of the directions and the number of the directions are arbitrary. In addition, a plurality of candidates may be set in a single direction. For example, in the example in FIG. 7, the block V2 and the block V3 which are positioned in the vertical direction of the co-located block may be the candidates of the reference block. In addition, all of the block V0 to block V2 may be included in the candidates of the reference block. In these cases, the image coding apparatus 100 may set viewpoint prediction information (for example, length_from_col2 and length_from_col3) for the block V2 and the block V3, and may transmit the viewpoint prediction information to the decoding side apparatus (the image decoding apparatus 300). It is apparent that a block which is positioned in the oblique direction of the co-located block can be set to the candidate of the reference block.

However, if the number of candidates increases, the improvement in prediction accuracy is expected. However, since the load of the prediction process and coding amount increase to that extent, it is preferable to comprehensively determine those facts and set the number of candidates to an appropriate value. In addition, the direction of each candidate is arbitrary, and it is preferable to provide the direction of the candidate along the direction of the parallax between views. Meanwhile, hereinbefore, an example of a two-viewpoint 3D image has been mainly described as an image of a coding and decoding target. However, any of a plurality number of viewpoints of the image, which is the coding and decoding target, may be used. That is, an image which is the processing target of the image coding apparatus 100 or the image decoding apparatus 300 may be a multi-viewpoint video picture of three or more viewpoints (three or more number of views).

In addition, description has been made so as to provide a plurality of pieces of information (length_from_col0 and length_from_col1) indicative of the distance from the co-located block of a neighbour block in the parallax direction, which is used as the candidate of the reference block, as the parallax prediction information. However, the plurality of pieces of information may be combined into a single piece of information. That is, with regard to the parallax prediction, the distance from the co-located block of each candidate may be in common (length_from_col). In this manner, the coding amount of the parallax prediction information is reduced, and thus it is possible to improve coding efficiency.

Meanwhile, the parallax prediction information (length_from_col) may be included in a sequence header. For example, in a case of the same relationship between the viewpoints of the cameras, the length_from_col information varies a little, and thus it is possible to reduce the coding amount by including the parallax prediction information in the sequence header.

In addition, the transmission of information which is determined in advance between the image coding apparatus 100 and the image decoding apparatus 300 (information known to both apparatuses) can be omitted.

For example, in a use where the relationship between viewpoints is substantially identical like a stereo image, the length_from_col information is determined in advance between the image coding apparatus 100 and the image decoding apparatus 300, and thus it is not necessary to include the information in the stream. In this manner, it is possible to further improve coding efficiency.

Hereinbefore, the temporal prediction block of a coded picture of the same viewpoint at different time is distinguished from the viewpoint correction block of the coded picture of different viewpoint at the same time, so as to be used as candidates. However, in order to reduce the processing amount, the temporal prediction block and the viewpoint correction block may be used as candidates even in a case of the coded picture of the same viewpoint or in a case of a coded picture of a different viewpoint.

### 4. Fourth Embodiment

### Computer

The above-described series of processes can be performed using either hardware or software. When the series of processes are performed using software, a program which constructs the software is installed in a computer. Here, the computer includes a computer in which dedicated hardware is embedded, and, for example, a general-purpose personal computer which can perform various types of functions by installing various types of programs.

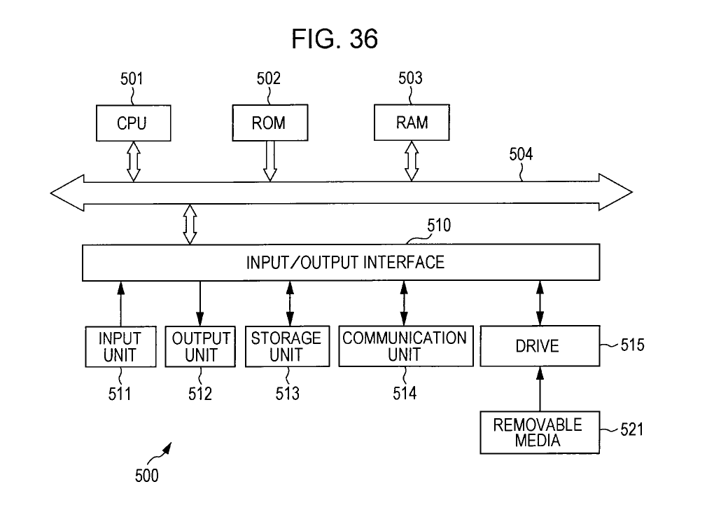

FIG. 36 is a block diagram illustrating an example of the configuration of the hardware of a computer which executes the above-described series of processes using a program.

In a computer 500 shown in FIG. 36, a Central Processing Unit (CPU) 501, a Read Only Memory (ROM) 502, and a Random Access Memory (RAM) 503 are connected to each other via a bus 504.

In addition an input/output interface 510 is connected to the bus 504. An input unit 511, an output unit 512, a storage unit 513, a communication unit 514, and a drive 515 are connected to the input/output interface 510.

The input unit 511 includes, for example, a keyboard, a mouse, a microphone, a touch panel, and an input terminal. The output unit 512 includes, for example, a display, a speaker, and an output terminal. The storage unit 513 includes, for example, a hard disk, a RAM disk, and a non-volatile memory. The communication unit 514 includes, for example, a network interface. The drive 515 drives a removable media 521, such as a magnetic disc, an optical disc, a magneto-optical disk, or a semiconductor memory.

In the computer 500 which is configured as described above, the above-described series of processes are performed in such a way that the CPU 501 loads a program which is stored in, for example, the storage unit 513 on the RAM 503 via the input/output interface 510 and the bus 504, and executes the program. In addition, data which is necessary for the CPU 501 to perform various types of processes are appropriately stored in the RAM 503.

A program performed by the computer (the CPU 501) can be recorded and used in, for example, the removable media 521 which functions as a package media. In addition, the program can be provided via wired or wireless transmission media, such as a local area network, the Internet, or digital satellite service.

In the computer, the program can be installed in the storage unit 513 via the input/output interface 510 by mounting the removable media 521 on the drive 515. In addition, the program is received by the communication unit 514 via the wired or wireless transmission media, and can be installed in the storage unit 513. In addition, the program can be installed in the ROM 502 or the storage unit 513 in advance.

Meanwhile, a program which is executed by the computer may be a program which is processed in chronological order along the order described in the present specification, and may be a program which is processed in parallel or at a necessary timing in which a call is made.

In addition, in the present specification, a step which describes a program to be recorded in a recording medium may include a process which is processed in chronological order along the written order, and may include a process which is performed in parallel or individually instead of being necessarily processed in chronological order.

In addition, in the present specification, the system means a set of a plurality of components (apparatuses and modules (products)), and it does not matter whether all the components are included in the same housing. Therefore, either a plurality of apparatuses, which are stored in an individual housing and connected over a network, or a single apparatus, in which a plurality of modules are stored in a single housing, may be a system.

In addition, as described above, a configuration which is described as a single apparatus (or a processing unit) may be shared between a plurality of apparatuses (or processing units). In contrast, the configuration described using the plurality of apparatuses (or processing units) may combine into a configuration using a single apparatus (or a processing unit). In addition, other configurations may be added to the configuration of each apparatus (or each processing unit) in addition to the above-described configuration. Further, if the configuration or the operation as the whole system is substantially the same, a part of the configuration of an apparatus (or a processing unit) may be included in the configuration of another apparatus (or another processing unit).

Hereinbefore, although the preferable embodiments of the present disclosure have been described in detail with reference to the accompanying drawings, the technical scope of the present disclosure is not limited to the examples. It is apparent that those skilled in the technical field of the present disclosure can understand various types of modifications or alternations within the scope of the technical spirit disclosed in the range of the claims, and it is understood that they are apparently included in the technical scope of the present disclosure.

For example, the present technology may use the configuration of cloud computing which shares a single function between a plurality of apparatuses over a network and jointly processes the function.

In addition, the respective steps which have been described in the above-described flowcharts can be performed using a single apparatus and can be shared between a plurality of apparatuses.

Further, when a plurality of processes are included in a single step, the plurality of processes included in the single step can be performed in a single apparatus and can be shared between a plurality of apparatuses.

The image coding apparatus 100 (FIG. 8) and the image decoding apparatus 300 (FIG. 24) according to the above-described embodiments may be applied to various types of electronic apparatuses, such as a transmission device or a reception device which is used for satellite broadcasting, wired broadcasting such as cable TV, transmission on the Internet, and transmission to a terminal using cellular communication, a recording apparatus which records images on a medium, such as an optical disk, a magnetic disc, and a flash memory, and a reproduction apparatus which reproduces an image from these storage medium. Hereinafter, four application examples will be described.

### 5. Fifth Embodiment

### 5-1. Application Example 1

### Television Apparatus

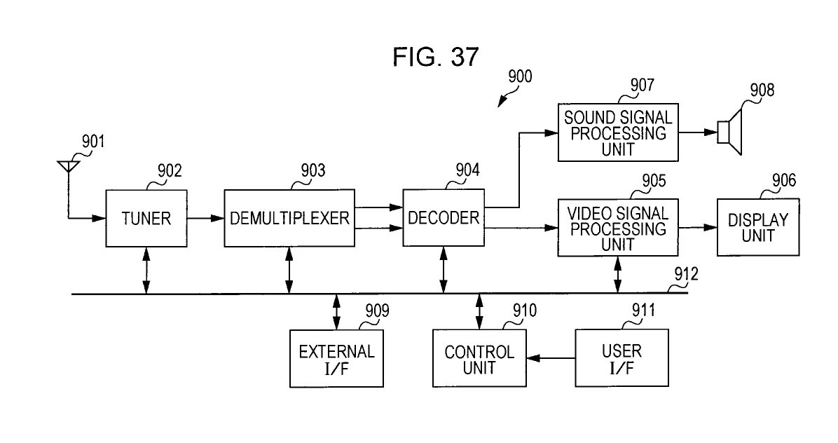

FIG. 37 illustrates an example of the schematic configuration of a television apparatus to which the above-described embodiments are applied. A television apparatus 900 includes an antenna 901, a tuner 902, a demultiplexer 903, a decoder 904, a video signal processing unit 905, a display unit 906, a sound signal processing unit 907, a speaker 908, an external interface 909, a control unit 910, a user interface 911, and a bus 912.

The tuner 902 extracts a desired channel signal from broadcasting signals which are received via the antenna 901, and demodulates the extracted signal. Thereafter, the tuner 902 outputs a coded bit stream which is obtained through the demodulation to the demultiplexer 903. That is, the tuner 902 has a function as a transmission unit of the television apparatus 900 which receives the coded stream in which an image is coded.

The demultiplexer 903 separates a video stream and a sound stream of a watching target program from the coded bit stream, and outputs each of the separated streams to the decoder 904. In addition, the demultiplexer 903 extracts subsidiary data, such as Electronic Program Guide (EPG), from the coded bit stream, and supplies the extracted data to the control unit 910. Meanwhile, the demultiplexer 903 may perform descrambling when the coded bit stream is scrambled.

The decoder 904 decodes the video stream and the sound stream which are input from the demultiplexer 903. Thereafter, the decoder 904 outputs video data which is generated by performing a decoding process to the video signal processing unit 905. In addition, the decoder 904 outputs sound data which is generated by performing the decoding process to the sound signal processing unit 907.

The video signal processing unit 905 reproduces the video data which is input from the decoder 904, and displays video on the display unit 906. In addition, the video signal processing unit 905 may display an application screen which is supplied over a network on the display unit 906. In addition, the video signal processing unit 905 may perform an additional process, for example, noise removal, on the video data depending on setting. Further, the video signal processing unit 905 may generate a Graphical User Interface (GUI) image, for example, a menu, a button, or a cursor, and may cause the generated image to be overlapped with the output image.

The display unit 906 is driven in response to a driving signal which is supplied from the video signal processing unit 905, and displays a video or an image on the video screen of a display device (for example, a liquid crystal display, a plasma display, or an Organic Electro-Luminescence Display (OELD)).

The sound signal processing unit 907 performs a reproduction process, such as D/A conversion and amplification, on the sound data which is input from the decoder 904, and outputs the sound from the speaker 908. In addition, the sound signal processing unit 907 may perform an additional process, such as noise removal, on the sound data.

The external interface 909 is an interface which is used to connect the television apparatus 900 to an external apparatus or a network. For example, the video stream or the sound stream which is received via the external interface 909 may be decoded by the decoder 904. That is, the external interface 909 further has a function as the transmission unit of the television apparatus 900 which receives a coded stream in which an image is coded.

The control unit 910 includes a processor such as a CPU, and a memory such as a RAM or a ROM. The memory stores a program which is executed by the CPU, program data, EPG data, and data which is acquired over a network. The program which is stored by the memory is read and executed by the CPU when, for example, the television apparatus 900 is driven. The CPU controls the operation of the television apparatus 900 by executing the program in response to, for example, the operation signal which is input from the user interface 911.

The user interface 911 is connected to the control unit 910. The user interface 911 includes, for example, buttons and switches used for the user to operate the television apparatus 900, and a remote control signal reception unit. The user interface 911 generates an operation signal via these components by detecting an operation performed by the user, and outputs the generated operation signal to the control unit 910.

The bus 912 connects the tuner 902, the demultiplexer 903, the decoder 904, the video signal processing unit 905, the sound signal processing unit 907, the external interface 909, and the control unit 910 to each other.

In the television apparatus 900 which is configured as described above, the decoder 904 has the function of the image decoding apparatus 300 (FIG. 24) according to the above-described embodiments. Therefore, the television apparatus 900 can implement the improvement in coding efficiency.

### 5-2. Application Example 2

### Mobile Phone

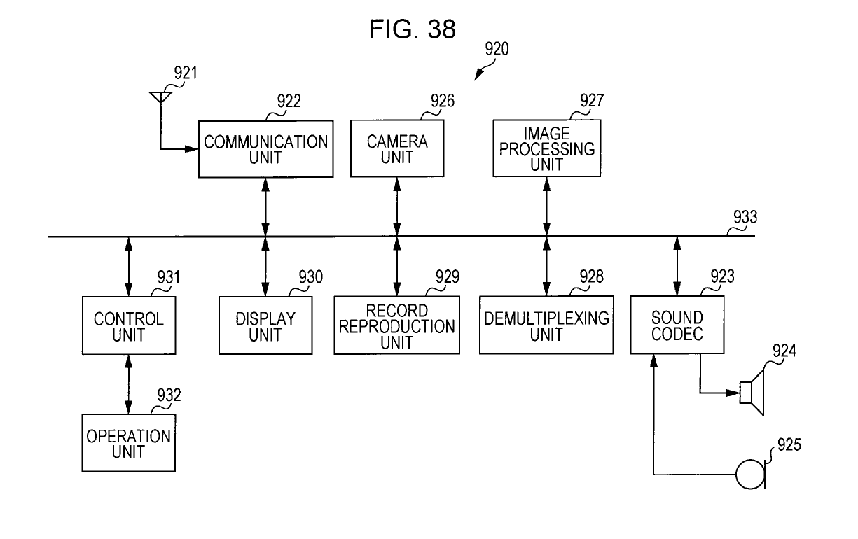

FIG. 38 illustrates an example of the schematic configuration of a mobile phone to which the above-described embodiments are applied. The mobile phone 920 includes an antenna 921, a communication unit 922, a sound codec 923, a speaker 924, a microphone 925, a camera unit 926, an image processing unit 927, a demultiplexing unit 928, a record reproduction unit 929, a display unit 930, a control unit 931, an operation unit 932, and a bus 933.

The antenna 921 is connected to the communication unit 922. The speaker 924 and the microphone 925 are connected to the sound codec 923. The operation unit 932 is connected to the control unit 931. The bus 933 connects the communication unit 922, the sound codec 923, the camera unit 926, the image processing unit 927, the demultiplexing unit 928, the record reproduction unit 929, the display unit 930, and the control unit 931 to each other.

The mobile phone 920 performs operations, such as transmission and reception of a sound signal, transmission and reception of e-mail or image data, image capturing, and data recording in various types of operational modes which include a sound conversation mode, a data communication mode, a picture-taking mode, and a TV telephone mode.

In the sound conversation mode, an analog sound signal which is generated by the microphone 925 is supplied to the sound codec 923. The sound codec 923 converts the analog sound signal into sound data, performs A/D conversion on the converted sound data, and then compresses the sound data obtained through the A/D conversion. Thereafter, the sound codec 923 outputs the sound data, obtained after the compression is performed, to the communication unit 922. The communication unit 922 generates a transmission signal by coding and modulating the sound data. Thereafter, the communication unit 922 transmits the generated transmission signal to a base station (not shown) via the antenna 921. In addition, the communication unit 922 acquires a reception signal by amplifying a wireless signal, which is received via the antenna 921, and performing frequency conversion on the wireless signal. Thereafter, the communication unit 922 generates sound data by demodulating and decoding the reception signal, and outputs the generated sound data to the sound codec 923. The sound codec 923 generates an analog sound signal by expanding the sound data and performing D/A conversion on the sound data. Thereafter, the sound codec 923 outputs the sound by supplying the generated sound signal to the speaker 924.

In addition, in the data communication mode, for example, the control unit 931 generates text data which constructs e-mail depending on an operation performed by a user using the operation unit 932. In addition, the control unit 931 displays the text on the display unit 930. In addition, the control unit 931 generates e-mail data depending on a transmission instruction from the user using the operation unit 932, and outputs the generated e-mail data to the communication unit 922. The communication unit 922 generates a transmission signal by coding and modulating the e-mail data. Thereafter, the communication unit 922 transmits the generated transmission signal to the base station (not shown) via the antenna 921. In addition, the communication unit 922 acquires a reception signal by amplifying and performing frequency conversion on a wireless signal which is received via the antenna 921. Thereafter, the communication unit 922 restores the e-mail data by demodulating and decoding the reception signal, and outputs the restored e-mail data to the control unit 931. The control unit 931 displays the content of the e-mail on the display unit 930, and stores the e-mail data in the recording medium of the record reproduction unit 929.

The record reproduction unit 929 includes an arbitrary storage medium which can be read and written. For example, the storage medium may be an embedded storage medium, such as RAM or a flash memory, or may be a storage medium which is installed outside, such as a hard disk, a magnetic disc, a magneto-optical disc, an optical disk, a USB memory, or a memory card.

In addition, in the imaging mode, for example, the camera unit 926 images a subject, generates image data, and outputs the generated image data to the image processing unit 927. The image processing unit 927 codes the image data which is input from the camera unit 926, and stores a coded stream in the storage medium of the record reproduction unit 929.

In addition, in the TV telephone mode, for example, the demultiplexing unit 928 multiplexes a video stream which is coded by the image processing unit 927, and a sound stream which is input from the sound codec 923, and outputs the multiplexed stream to the communication unit 922. The communication unit 922 generates a transmission signal by coding and modulating the stream. Thereafter, the communication unit 922 transmits the generated transmission signal to the base state (not shown) via the antenna 921. In addition, the communication unit 922 acquires a reception signal by amplifying and performing frequency conversion on a wireless signal which is received via the antenna 921. A coded bit stream is included in the transmission signal and the reception signal. Thereafter, the communication unit 922 restores the stream by demodulating and decoding the reception signal, and outputs the restored stream to the demultiplexing unit 928. The demultiplexing unit 928 separates the video stream and the sound stream from the input stream, outputs the video stream to the image processing unit 927, and outputs the sound stream to the sound codec 923. The image processing unit 927 generates video data by decoding the video stream. The video data is supplied to the display unit 930, and a series of images are displayed by the display unit 930. The sound codec 923 generates an analog sound signal by expanding the sound stream and performing D/A conversion on the sound stream.

Thereafter, the sound codec 923 outputs the sound by supplying the generated sound signal to the speaker924.

In the mobile phone 920 which is configured as described above, the image processing unit 927 includes the function of the image coding apparatus 100 (FIG. 8) and the function of the image decoding apparatus 300 (FIG. 24) according to the above-described embodiments. Therefore, the mobile phone 920 can improve coding efficiency.

In addition, hereinbefore, the mobile phone 920 has been described. However, if an apparatus, for example, a Personal Digital Assistant (PDA), a smart phone, an Ultra Mobile Personal Computer (UMPCs), a network, or a notebook-type personal computer, has the same imaging function or a communication function as the mobile phone 920, it is possible to apply an image coding apparatus and an image decoding apparatus, to which the present technology is applied, to any type of apparatuses, like the case of the mobile phone 920.

### 5-3. Application Example

### Record Reproduction Apparatus

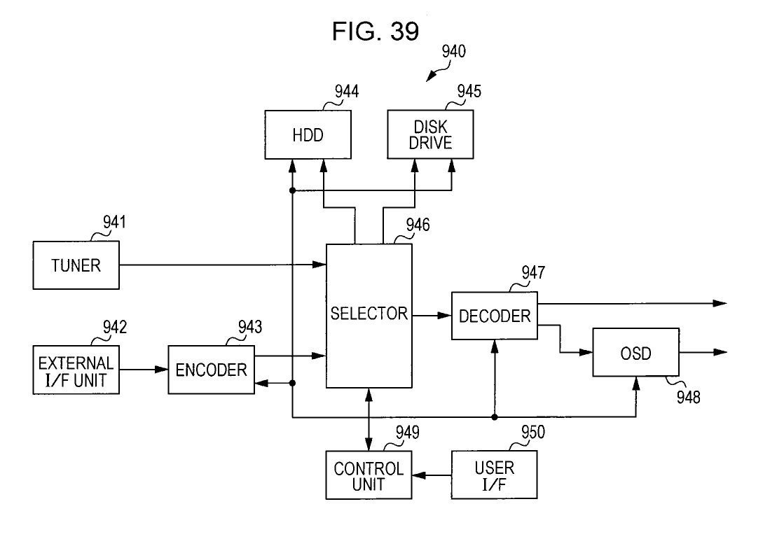

FIG. 39 illustrates an example of the schematic configuration of a record reproduction apparatus to which the above-described embodiments are applied. A record reproduction apparatus 940 codes, for example, the sound data and the video data of a received broadcasting program, and records them in a recording medium. In addition, the record reproduction apparatus 940 may code, for example, the sound data and the video data which are acquired from another apparatus, and records them in the recording medium. In addition, the record reproduction apparatus 940 reproduces the data which is recorded in the recording medium on a monitor or a speaker in response to, for example, an instruction from the user. At this time, the record reproduction apparatus 940 decodes the sound data and the video data.

The record reproduction apparatus 940 includes a tuner 941, an external interface 942, an encoder 943, a Hard Disk Drive (HDD) 944, a disk drive 945, a selector 946, a decoder 947, an On-Screen Display (OSD) 948, a control unit 949, and a user interface 950.

The tuner 941 extracts a desired channel signal from a broadcasting signal which is received via an antenna (not shown), and demodulates the extracted signal. Thereafter, the tuner 941 outputs a coded bit stream which is obtained through the demodulation to the selector 946. That is, the tuner 941 has a function as the transmission unit of the record reproduction apparatus 940.

The external interface 942 is an interface which connects the record reproduction apparatus 940 to an external apparatus or a network. The external interface 942 may include, for example, an IEEE1394 interface, a network interface, an USB interface, or a flash memory interface. For example, the video data and the sound data which are received via the external interface 942 are input to the encoder 943. That is, the external interface 942 has a function as the transmission unit of the record reproduction apparatus 940.

When the video data and the sound data which are input from the external interface 942 are not coded, the encoder 943 codes the video data and the sound data. Thereafter, the encoder 943 outputs a coded bit stream to the selector 946.

The HDD 944 records the coded bit stream in which content data, such as the video and sound, is compressed, various types of programs and the other data in an internal hard disk. In addition, the HDD 944 reads those data from the hard disk when the video and the sound are reproduced.

The disk drive 945 records and reads the data in and from an installed recording medium. The recording medium which is installed in the disk drive 945 may include, for example, a DVD disk (DVD-Video, DVD-RAM, DVD-R, DVD-RW, DVD+R, or DVD+RW) and a Blu-ray (registered trademark) disk.

When the video and the sound are recorded, the selector 946 selects the coded bit stream which is input from the tuner 941 or the encoder 943, and outputs the selected coded bit stream to the HDD 944 or the disk drive 945. In addition, when the video and the sound are reproduced, the selector 946 outputs the coded bit stream, which is input from the HDD 944 or the disk drive 945, to the decoder 947.

The decoder 947 decodes the coded bit stream, and generates the video data and the sound data. Thereafter, the decoder 947 outputs the generated video data to the OSD 948. In addition, the decoder 904 outputs the generated sound data to an external speaker.

The OSD 948 reproduces the video data which is input from the decoder 947, and displays the video. In addition, the OSD 948 may cause the displayed video to be overlapped with, for example, the image of a GUI such as a menu, a button, or a cursor.

The control unit 949 includes a processor such as the CPU, and a memory such as a RAM or a ROM. The memory stores a program which is executed by the CPU, and stores the program data. The program, which is stored in the memory, is read by the CPU and executed when, for example, the record reproduction apparatus 940 is driven. The CPU controls the operation of the record reproduction apparatus 940 by executing the program in response to, for example, an operation signal which is input from the user interface 950.

The user interface 950 is connected to the control unit 949. The user interface 950 includes, for example, buttons and switches which are used for the user to operate the record reproduction apparatus 940, and a remote control signal reception unit. The user interface 950 generates an operation signal by detecting an operation which is performed by the user via these components, and outputs the generated operation signal to the control unit 949.

In the record reproduction apparatus 940 which is configured as described above, the encoder 943 includes the functions of the image coding apparatus 100 (FIG. 8) according to the above-described embodiments. In addition, the decoder 947 includes the functions of the image decoding apparatus 300 (FIG. 24) according to the above-described embodiments. Therefore, the record reproduction apparatus 940 can improve coding efficiency.

### 5-4. Application Example 4

### Imaging Apparatus

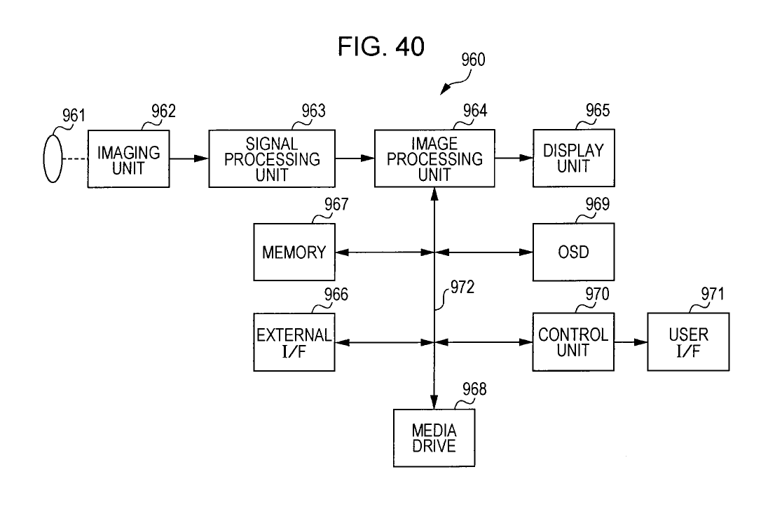

FIG. 40 illustrates an example of the schematic configuration of an imaging apparatus to which the above-described embodiments are applied. An imaging apparatus 960 generates an image by imaging a subject, codes image data, and records the coded image data in a recording medium.

The imaging apparatus 960 includes an optical block 961, an imaging unit 962, a signal processing unit 963, an image processing unit 964, a display unit 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the media drive 968, the OSD 969, and the control unit 970 to each other.

The optical block 961 includes a focus lens and an aperture mechanism. The optical block 961 forms an optical image of a subject on the imaging surface of the imaging unit 962. The imaging unit 962 includes an image sensor such as a CCD or a CMOS, and converts the optical image which is formed on the imaging surface into an image signal which functions as an electrical signal by performing photoelectric conversion. Thereafter, the imaging unit 962 outputs the image signal to the signal processing unit 963.

The signal processing unit 963 performs various camera signal processes, such as knee correction, gamma correction, and color correction on the image signal which is input from the imaging unit 962. The signal processing unit 963 outputs image data, acquired after the camera signal process is performed, to the image processing unit 964.

The image processing unit 964 codes the image data which is input from the signal processing unit 963, and generates coded data. Thereafter, the image processing unit 964 outputs the generated coded data to the external interface 966 or the media drive 968. In addition, the image processing unit 964 decodes the coded data which is input from the external interface 966 or the media drive 968, and generates image data. Thereafter, the image processing unit 964 outputs the generated image data to the display unit 965. In addition, the image processing unit 964 may display an image by outputting the image data which is input from the signal processing unit 963 to the display unit 965. In addition, the image processing unit 964 may cause display data which is acquired from the OSD 969 to be overlapped with the image which is output to the display unit 965.

The OSD 969 generates, for example, a GUI image, such as a menu, a button, or a cursor, and outputs the generated image to the image processing unit 964.

The external interface 966 is configured as, for example, a USB input/output terminal. For example, when an image is printed, the external interface 966 connects the imaging apparatus 960 to a printer. In addition, a drive is connected to the external interface 966 when necessary. For example, a removable media, such as a magnetic disk or an optical disk, is mounted on the drive, and a program which is read from the removable media may be installed in the imaging apparatus 960. Further, the external interface 966 may be configured as a network interface which is connected to a network such as a LAN or the Internet. That is, the external interface 966 has a function as the transmission unit of the imaging apparatus 960.

The recording medium which is mounted on the media drive 968 may be, for example, an arbitrary removable media for reading and writing, such as a magnetic disk, a magneto-optic disk, an optical disk, or a semiconductor memory. In addition, the recording medium may be fixedly mounted on the media drive 968, and thus may be configured by a non-transportable storage unit, such as a built-in hard disk drive or a Solid State Drive (SSD), for example.

The control unit 970 includes a processor such as the CPU, and a memory such as a RAM or a ROM. The memory stores a program which is executed by the CPU, and stores program data. The program, which is stored in the memory, is read by the CPU and executed when, for example, the imaging apparatus 960 is driven. The CPU controls the operation of the imaging apparatus 960 by executing the program in response to, for example, an operation signal which is input from the user interface 971.

The user interface 971 is connected to the control unit 970. The user interface 971 includes, for example, buttons and switches which are used for the user to operate the imaging apparatus 960. The user interface 971 generates the operation signal by detecting an operation which is performed by the user via these components, and outputs the generated operation signal to the control unit 970.

In the imaging apparatus 960 which is configured as described above, the image processing unit 964 includes the functions of the image coding apparatus 100 (FIG. 8) according to the above-described embodiments, and the functions of the image decoding apparatus 300 (FIG. 24). Therefore, the imaging apparatus 960 can improve coding efficiency.

It is apparent that the image coding apparatus and the image decoding apparatus to which the present technology is applied can be applied to an apparatus or a system in addition to the above-described apparatuses.

Meanwhile, in the specification, an example in which a quantization parameter is transmitted from a coding side to a decoding side has been described. As a method of transmitting a quantization parameter, the quantization parameter may be transmitted or recorded as individual data, which is associated with the coded bit stream, without being multiplexed into the coded bit stream. Here, the term of “associate” means that an image (which may be a part of the image, such as a slice or a block) included in a bit stream is caused to be linked with information corresponding to the image, when decoding is performed. That is, the information may be transmitted on a different transmission path from the image (or the bit stream). In addition, the information may be recorded in a different recording medium (or the different recording area of the same recording medium) from the image (or the bit stream). Further, the information and the image (or the bit stream) may be associated with each other in an arbitrary unit, for example, such as a unit of a plurality of frames, a single frame, or a part of the frame.

Meanwhile, the present technology can include a configuration as follows:

(1) An image processing apparatus includes: a generation unit that generates a plurality of pieces of reference block information indicative of different blocks of coded images, which have viewpoints different from a viewpoint of an image of a current block, as reference blocks which refer to motion information; a selection unit that selects a block which functions as a referent of the motion information from among the blocks respectively indicated by the plurality of pieces of reference block information which are generated by the generation unit; a coding unit that codes a differential image between a prediction image of the current block, which is generated with reference to the motion information of the block selected by the selection unit, and the image of the current block; and a transmission unit that transmits coded data, which is generated by the coding unit, and the reference block information indicative of the block selected by the selection unit.

(2) In the image processing apparatus of (1), the pieces of reference block information are pieces of identification information to identify the reference blocks.

(3) In the image processing apparatus of (1) or (2), the respective reference blocks are blocks which are positioned in different directions, separated from each other from co-located blocks, which are at a same position as the current block, of the coded images which have the viewpoints different from the viewpoint of the image of the current block.

(4) In the image processing apparatus of any one of (1) to (3), the transmission unit transmits pieces of viewpoint prediction information indicative of positions of the respective reference blocks of the coded images which have the viewpoints different from the viewpoint of the image of the current block.

(5) In the image processing apparatus of any one of (1) to (4), the pieces of viewpoint prediction information are pieces of information indicative of relative positions of the reference blocks from the co-located blocks located at the same position as the current block.

(6) In the image processing apparatus of (5), the pieces of viewpoint prediction information include pieces of information indicative of distances of the reference blocks from the co-located blocks.

(7) In the image processing apparatus of (6), the pieces of viewpoint prediction information include a plurality of pieces of information indicative of the distances of the reference blocks which are different from each other.

(8) In the image processing apparatus of (6) or (7), the viewpoint prediction information further include pieces of information indicative of directions of the respective reference blocks from the co-located blocks.

(9) In the image processing apparatus of any of (1) to (8), the transmission unit transmits pieces of flag information indicative of whether or not to use the blocks of the coded images, which have the viewpoints different from the viewpoint of the image of the current block, as the reference blocks.

(10) In the image processing apparatus of any of (1) to (9), the coding unit multi-view codes the images.

(11) An image processing method of an image processing apparatus, includes generating a plurality of pieces of reference block information indicative of different blocks of coded images, which have viewpoints different from a viewpoint of an image of a current block, as reference blocks which refer to motion information; selecting a block which functions as a referent of the motion information from among the blocks respectively indicated by the generated plurality of pieces of reference block information; coding a differential image between a prediction image of the current block, which is generated with reference to the motion information of the selected block, and the image of the current block; and transmitting generated coded data and the reference block information indicative of the block selected by the selection unit.

(12) An image processing apparatus, includes: a reception unit that receives pieces of reference block information indicative of reference blocks which are selected as referents of motion information from among a plurality of blocks of decoded images, which have viewpoints different from a viewpoint of an image of a current block; a generation unit that generates motion information of the current block using pieces of motion information of the reference blocks which are indicated using the pieces of reference block information received by the reception unit; and a decoding unit that decodes coded data of the current block using the motion information which is generated by the generation unit.

(13) In the image processing apparatus of (12), the pieces of reference block information are pieces of identification information indicative of the reference blocks.

(14) In the image processing apparatus of (12) or (13),

the plurality of blocks of the decoded images, which have viewpoints different from the viewpoint of the image of the current block, are blocks which are separately positioned in different directions from each other from co-located blocks which are at a same position as the current block.

(15) In the image processing apparatus of any one of (12) to (14), further including a specification unit that specifies the reference blocks. The reception unit receives pieces of viewpoint prediction information indicative of positions of the reference blocks of the decoded images, which have viewpoints different from the viewpoint of the image of the current block, the specification unit specifies the reference blocks using the pieces of reference block information received by the reception unit and the pieces of viewpoint prediction information, and the generation unit generates the motion information of the current block using the pieces of motion information of the reference blocks which are specified by the specification unit.

(16) In the image processing apparatus of (15), the pieces of viewpoint prediction information are pieces of information indicative of relative positions of the reference blocks from the co-located blocks which are at the same position as the current block.

(17) In the image processing apparatus of (16), the pieces of viewpoint prediction information include pieces of information indicative of distances of the reference blocks from the co-located blocks.

(18) In the image processing apparatus of (17), the pieces of viewpoint prediction information include a plurality of pieces of information indicative of the distances of the reference blocks which are different from each other.

(19) In the image processing apparatus of (17) or (18), the viewpoint prediction information further include pieces of information indicative of directions of the respective reference blocks from the co-located blocks.

(20) An image processing method of an image processing apparatus, includes: receiving pieces of reference block information indicative of reference blocks which are selected as referents of motion information from among a plurality of blocks of decoded images, which have different viewpoints from a viewpoint of an image of a current block; generating motion information of the current block using pieces of motion information of the reference blocks which are indicated using the received pieces of reference block information; and a decoding unit that decodes coded data of the current block using the generated motion information.

The present disclosure contains subject matter related to that disclosed in Japanese Priority Patent Application JP 2012-077823 filed in the Japan Patent Office on Mar. 29, 2012, the entire contents of which are hereby incorporated by reference.

What is claimed is:

1. An image processing apparatus comprising:
a generation unit that generates a plurality of pieces of reference block information indicative of different blocks of coded images, which have different viewpoints from a viewpoint of an image of a current block, as reference blocks which refer to motion information;
a selection unit that selects a block which functions as a referent of the motion information from among the blocks respectively indicated by the plurality of pieces of reference block information which are generated by the generation unit;
a coding unit that codes a differential image between a prediction image of the current block, which is generated with reference to the motion information of the block selected by the selection unit, and the image of the current block; and
a transmission unit that transmits coded data, which is generated by the coding unit, and the reference block information indicative of the block selected by the selection unit.

2. The image processing apparatus according to claim 1,
wherein the pieces of reference block information are pieces of identification information to identify the reference blocks.

3. The image processing apparatus according to claim 1,
wherein the respective reference blocks are blocks which are positioned in different directions, separated from each other from co-located blocks, which are at a same position as the current block, of the coded images which have the viewpoints different from the viewpoint of the image of the current block.

4. The image processing apparatus according to claim 1,
wherein the transmission unit transmits pieces of viewpoint prediction information indicative of positions of the respective reference blocks of the coded images which have the viewpoints different from the viewpoint of the image of the current block.

5. The image processing apparatus according to claim 1,
wherein the pieces of viewpoint prediction information are pieces of information indicative of relative positions of the reference blocks from the co-located blocks located at the same position as the current block.

6. The image processing apparatus according to claim 5,
wherein the pieces of viewpoint prediction information include pieces of information indicative of distances of the reference blocks from the co-located blocks.

7. The image processing apparatus according to claim 6,
wherein the pieces of viewpoint prediction information include a plurality of pieces of information indicative of the distances of the reference blocks which are different from each other.

8. The image processing apparatus according to claim 6,
wherein the pieces of the viewpoint prediction information further include pieces of information indicative of directions of the respective reference blocks from the co-located blocks.

9. The image processing apparatus according to claim 1,
wherein the transmission unit transmits pieces of flag information indicative of whether or not to use the blocks of the coded images, which have the different viewpoints from the viewpoint of the image of the current block, as the reference blocks.

10. The image processing apparatus according to claim 1,
wherein the coding unit multi-view codes the images.

11. An image processing method of an image processing apparatus, comprising:
generating a plurality of pieces of reference block information indicative of different blocks of coded images, which have different viewpoints from a viewpoint of an image of a current block, as reference blocks which refer to motion information;
selecting a block which functions as a referent of the motion information from among the blocks respectively indicated by the generated plurality of pieces of reference block information;
coding a differential image between a prediction image of the current block, which is generated with reference to the motion information of the selected block, and the image of the current block; and
transmitting generated coded data and the reference block information indicative of the selected block.

12. An image processing apparatus, comprising:
a reception unit that receives pieces of reference block information indicative of reference blocks which are selected as referents of motion information from among a plurality of blocks of decoded images, which have viewpoints different from a viewpoint of an image of a current block;
a generation unit that generates motion information of the current block using pieces of motion information of the reference blocks which are indicated using the pieces of reference block information received by the reception unit; and
a decoding unit that decodes coded data of the current block using the motion information which is generated by the generation unit.

13. The image processing apparatus according to claim 12,
wherein the pieces of reference block information are pieces of identification information indicative of the reference blocks.

14. The image processing apparatus according to claim 12,
wherein the plurality of blocks of the decoded images, which have different viewpoints from the viewpoint of the image of the current block, are blocks which are separately positioned in different directions from each other from co-located blocks which are at a same position as the current block.

15. The image processing apparatus according to claim 12, further comprising:
a specification unit that specifies the reference blocks,
wherein the reception unit receives pieces of viewpoint prediction information indicative of positions of the reference blocks of the decoded images, which have different viewpoints from the viewpoint of the image of the current block,
wherein the specification unit specifies the reference blocks using the pieces of reference block information received by the reception unit and the pieces of viewpoint prediction information, and
wherein the generation unit generates the motion information of the current block using the pieces of motion information of the reference blocks which are specified by the specification unit.

16. The image processing apparatus according to claim 15,
wherein the pieces of viewpoint prediction information are pieces of information indicative of relative positions of the reference blocks from the co-located blocks which are at the same position as the current block.

17. The image processing apparatus according to claim 16,
wherein the pieces of viewpoint prediction information include pieces of information indicative of distances of the reference blocks from the co-located blocks.

18. The image processing apparatus according to claim 17,
wherein the pieces of viewpoint prediction information include a plurality of pieces of information indicative of the distances of the reference blocks which are different from each other.

19. The image processing apparatus according to claim 17,
wherein the viewpoint prediction information further include pieces of information indicative of directions of the respective reference blocks from the co-located blocks.

20. An image processing method of an image processing apparatus, comprising:
receiving pieces of reference block information indicative of reference blocks which are selected as referents of motion information from among a plurality of blocks of decoded images, which have different viewpoints from a viewpoint of an image of a current block;
generating motion information of the current block using pieces of motion information of the reference blocks which are indicated using the received pieces of reference block information; and
a decoding unit that decodes coded data of the current block using the generated motion information.
